(19) United States
(12) Patent Application Publication
(10) Pub. No.: US 2015/0319828 A1
(43) Pub. Date: Nov. 5, 2015

(54) LIGHT EMITTING DIODE APPARATUS, SYSTEM, AND METHOD

(71) Applicant: NUWAVE LLC, Libertyville, IL (US)

(72) Inventors: Jung Sik MOON, Long Grove, IL (US); Eung Yub Cha, Glenview, IL (US); Eunjung Huh, Gurnee, IL (US); Jojo He, Huizhou (CN)

(73) Assignee: NUWAVE LLC, Libertyville, IL (US)

(21) Appl. No.: 14/799,385

(22) Filed: Jul. 14, 2015

Related U.S. Application Data
(63) Continuation-in-part of application No. 29/484,775, filed on Mar. 12, 2014, now abandoned.
(60) Provisional application No. 62/024,467, filed on Jul. 15, 2014.
(60) Provisional application No. 62/024,478, filed on Jul. 15, 2014.

(51) Int. Cl. H05B 37/02; H05B 33/08; F21S 8/04; F21V 23/04; F21V 23/00

(52) U.S. Cl. CPC H05B 37/0272; F21V 23/0435; F21V 23/0464; F21V 23/003; F21S 8/04; H05B 33/0854; H05B 37/0227; H05B 37/0236

(57) ABSTRACT

This patent application discloses a light emitting diode (LED) bulb apparatus, system and method. According to an exemplary embodiment, the LED system may include where the light emitting diode (LED) system may include: an LED lighting source device, which may include a plurality of LEDs; a controller coupled to said LED lighting source device configured to control said plurality of LEDs; and a wireless transceiver coupled to said controller and configured to wirelessly couple to a remote control device.

### CROSS-REFERENCE TO RELATED APPLICATIONS

This application is a US NonProvisional patent application claiming the benefit under 35 USC Section §119(e) of U.S. Provisional Utility Patent Application No. 62/156,191, filed May 2, 2015, and claims benefit of under 35 USC Section §119(e) of U.S. Provisional Patent Application 62/024,478, filed Jul. 15, 2014, entitled, “Light Emitting Diode Apparatus, System, and Method,” and claims benefit of under 35 USC Section §119(e) of U.S. Provisional Patent Application 62/024,467, filed Jul. 15, 2014, and is a continuation-in-part of, and claims priority under 35 USC §120 of U.S. Design patent application Ser. No. 29/484,775, filed Mar. 12, 2014, entitled “Light Bulb,” the contents of all of which are incorporated herein by reference in their entirety.

### BACKGROUND OF THE DISCLOSURE

1. Field of the Disclosure

The present disclosure relates generally to illumination devices, and more particularly to a light emitting diode (LED) bulb, wherein the LED bulb has various improvements over conventional light bulbs.

2. Related References

LEDs are solid state light emitting devices formed of semiconductors, which are more stable and reliable than other conventional light sources such as incandescent bulbs. LEDs are conventionally widely used in various fields such as alphanumeric display elements, signal lights, light sources for lighting, and display devices.

A conventional LED bulb includes a holder or holding plate, a substrate located at one end of the holder and a plurality of LEDs mounted on a typically planar mounting face of the substrate. Light distribution of conventional LED bulbs is mostly concentrated at a center axis while gradually weakening towards a periphery of the conventional LED bulb.

When the plurality of LEDs are arranged on the planar, light may be produced in typically one direction, which may result in uneven light intensity distribution. What is needed is an improved LED bulb which can overcome shortcomings of conventional light sources.

### SUMMARY OF THE DISCLOSURE

The present disclosure sets forth a light emitting diode (LED) lighting source apparatus, system and method.

According to an exemplary embodiment, the LED system may include where the light emitting diode (LED) system may include:
an LED lighting source device may include a plurality of LEDs;
a controller coupled to said LED lighting source device configured to control said plurality of LEDs; and
a wireless transceiver coupled to said controller and configured to wirelessly couple to a remote control device.

According to an exemplary embodiment, the LED system may include where the LED lighting source device comprises at least one of:

a troffer LED lighting source device;
a high bay LED lighting source device; or
a canopy LED lighting source device.

According to an exemplary embodiment, the LED system may include where the at least one of:

an illuminance sensing device;
a light sensor; or
a daylight harvesting sensor.

The LED system according to claim 1, further comprising:

The remote control device.

According to an exemplary embodiment, the LED system may include where the remote control device may include at least one of:

a special purpose remote control device; or

a smartphone configured with an application program.

According to an exemplary embodiment, the LED system may include where the the remote control device comprises at least one of:

a touchscreen;

at least one button;

at least one key;

an alphanumeric display;

a sensor;

a gesture sensor; or

a voice recognition sensor.

According to an exemplary embodiment, the LED system may include where the wireless transceiver comprises at least one of:

a WiFi wireless receiver;

a Bluetooth wireless receiver;

a zigbee protocol wireless receiver;

a local area network (LAN) wireless receiver; or

a wide area network (WAN) wireless receiver.

According to an exemplary embodiment, the LED system may further include where the at least one wireless communication antenna.

According to an exemplary embodiment, the LED system may include where there may include at least one illuminance sensor.

According to an exemplary embodiment, the LED system may include further include the at least one light sensor.

According to an exemplary embodiment, the LED system may include where the controller may include addressability of said plurality of LEDs in groups of at least one LED.

According to an exemplary embodiment, the LED system may include where the LED light source device comprises a colored LED light source device.

According to an exemplary embodiment, a light emitting diode (LED) bulb may include: a socket; a power driver electrically coupled to said socket; an LED plate comprising a plurality of LEDs, electrically coupled to said power driver; a holding plate adapted to dissipate heat from said LED plate; and a cover.

According to one exemplary embodiment, the LED bulb may include where said power driver may include an isolated power driver.

According to one exemplary embodiment, the LED bulb may include where the isolated power driver may include: a plastic housing isolating conductive components from contact with metal components, or a user of the LED bulb.

According to one exemplary embodiment, the LED bulb may further include a silicone cavity filling of any air pockets of the LED bulb so as to prevent movement of components an wires to reduce or eliminate shock risk.

According to one exemplary embodiment, the LED bulb may include where the holding plate may include at least one fin.

According to one exemplary embodiment, the LED bulb may include where the holding plate may include a solid aluminum plate with no air gap, surrounding the LED plate.

According to one exemplary embodiment, the LED bulb may include where the LED bulb may include at least one of: a desk lamp bulb; a vanity bulb; a tube bulb; a flood light bulb; a candle bulb; an omnidirectional bulb; a globe shaped bulb; a cylindrical tub shaped bulb; a globe shaped cover bulb; or a omnidirectional bulb may include a concavity.

According to one exemplary embodiment, the LED bulb may further include a pulse width modulation (PWM) dimming method.

According to one exemplary embodiment, the LED bulb may include where the PWM dimming method is configured to dim between 0-100 in up to 20% increments of granularity.

According to one exemplary embodiment, the LED bulb may include where the PWM dimming method is configured to dim between 0-100 in 1% increments of granularity.

According to one exemplary embodiment, the LED bulb may include where a wireless gateway wirelessly coupled to the LED bulb.

According to one exemplary embodiment, the LED bulb may include where the wireless gateway communicates with the LED bulb by at least one of: a wireless fidelity (WiFi) protocol; a bluetooth protocol; a broadband over powerline (BPL) communication method; a cable television connection; or a zigbee protocol.

According to one exemplary embodiment, the LED bulb may further include at least one of: a remote control device configured to communicate with said wireless gateway; a smartphone device and application program configured to communicate with said wireless gateway.

According to one exemplary embodiment, the LED bulb may further include an inverter configured to transform alternating current power to direct current power.

According to one exemplary embodiment, the LED bulb may include where the LED bulb is configured to reduce or eliminate risk of shock by isolating the all electronic components on the AC side of said inverter.

According to one exemplary embodiment, the LED bulb may further include at least one of: a light sensor; a luminance sensor; a daylight harvesting device; or a sensor.

According to one exemplary embodiment, the LED bulb may further include a diffuser at least one of inside, or outside of, the cover of the LED bulb.

According to one exemplary embodiment, the LED bulb may further include a reflector inside the LED bulb.

According to one exemplary embodiment, the LED bulb may further include a one-piece heat dissipation device where there is no space between the LED plate and a heat sink.

According to one exemplary embodiment, the LED bulb may include where the LED plate is slightly below said holding plate, and touches said LED plate directly to facilitate directly dissipating heat.

According to one exemplary embodiment, the LED bulb may include where the bulb is at least one of: weatherproof; or waterproof.

According to one exemplary embodiment, the LED bulb may include where the cover reflects and directs light 225 degrees without reflective material.

According to one exemplary embodiment, the LED bulb may include where the diffuser comprises a pyramid shaped plastic.

According to one exemplary embodiment, the LED bulb may include where the reflector comprises: an annular ring; and a truncated cone coupled to said annular ring.

According to one exemplary embodiment, the LED bulb may further include a plastic housing.

According to one exemplary embodiment, the LED bulb may include where the plastic housing comprises a bell-shaped cone.

According to one exemplary embodiment, the LED bulb may include where the cover comprises at least one of: glass; plastic; or silicone.

According to one exemplary embodiment, the LED bulb may include where the holding plate comprises at least one of: aluminum; or metal.

According to one exemplary embodiment, the LED bulb may further include empty space below the LED plate inside the LED bulb to facilitate heat dissipation.

According to one exemplary embodiment, a method of making an LED bulb may include: filling an air pocket of an LED bulb with silicone rubber; and allowing said silicone rubber to set.

### BRIEF DESCRIPTION OF THE DRAWINGS

FIG. 1 is an exemplary isometric perspective view of an exemplary troffer lighting apparatus, with exemplary communication and power driver components, according to an exemplary embodiment of the present disclosure;

FIG. 2 is an exemplary bottom orthographic view of the exemplary troffer lighting apparatus illustrating exemplary, but nonlimiting four (4) rows of exemplary light emitting diodes (LEDs), according to an exemplary embodiment of the present disclosure;

FIG. 3 is an exemplary top isometric view of the exemplary troffer lighting apparatus, illustrating an exemplary junction box, coupled via exemplary couplers to an exemplary driver housing, which may include an airtight, airfree driver electronics with airspace filled with silicone to isolate the driver electronics, according to an exemplary embodiment of the present disclosure;

FIG. 4 is an exemplary partial cutaway isometric view of an exemplary wireless receiver, illustrating an exemplary reset key and exemplary seal-ring according to an exemplary embodiment of the present disclosure;

FIG. 5 is an exemplary isometric top view of the exemplary troffer lighting apparatus with an exemplary wireless transceiver illustrated coupled to the apparatus, which may be a Zigbee protocol compliant exemplary wireless receiver, according to an exemplary embodiment of the present disclosure;

FIG. 6 is an exemplary partial cutaway isometric view of an exemplary troffer lighting fixture with an exemplary motion sensor, and an exemplary junction box according to the exemplary embodiment of the present disclosure;

FIG. 7 is an exemplary isometric perspective top view of an exemplary canopy lighting fixture with an electrical junction box atop it, according to an exemplary embodiment of the present disclosure;

FIG. 8 is an exemplary bottom isometric view of the exemplary canopy lighting fixture including a plurality of LED plates each with an exemplary plurality of LED modules, each with a substantially narrow candle socket candle LED light bulb according to an exemplary embodiment of the present disclosure;

FIG. 9 is an exemplary front side and isometric view illustrating an exemplary assembly method of the exemplary canopy light fixture illustrating a lead screw, nut and ceiling, according to an exemplary embodiment of the present disclosure;

FIG. 10 is an exemplary side isometric view of the exemplary canopy illustrating an exemplary motion sensor location and exemplary junction box according to an exemplary embodiment of the present disclosure;

FIG. 11 is an exemplary bottom isometric view of the exemplary canopy light fixture illustrating various exemplary rectangular LED plates each with an exemplary plurality of LEDs, according to an exemplary embodiment of the present disclosure;

FIG. 12 is an exemplary partial cutaway isometric view of the exemplary canopy lighting fixture illustrating an exemplary zigbee wireless transceiver module, including an exemplary zigbee transceiver location with an exemplary reset key and exemplary seal-ring, configured to seal out moisture in damp locations, according to an exemplary embodiment of the present disclosure;

FIG. 13 is an exemplary front side orthographic view of an exemplary high bay lighting fixture illustrating from the top an exemplary wiring conduit, leading to a dedicated electrical junction box, then to wireless transceiver and the metal housing, according to an exemplary embodiment of the present disclosure;

FIG. 14 is an exemplary cross-sectional partial cutaway front orthographic view of the exemplary high bay lighting fixture according to an exemplary embodiment of the present disclosure;

FIG. 15 is an exemplary side orthographic semi cutaway view of the exemplary high bay lighting fixture according to an exemplary embodiment of the present disclosure;

FIG. 16 is an exemplary bottom isometric view of the exemplary high bay lighting fixture illustrating a plurality of exemplary LED plate sector portions of an exemplary annular ring according to an exemplary embodiment of the present disclosure;

FIG. 17 is an exemplary side cutaway view of an exemplary high bay lighting fixture according to an exemplary embodiment of the present disclosure;

FIG. 18 is an exemplary isometric top view of the exemplary highbay lighting fixture illustrating an exemplary location for an exemplary wireless transceiver according to an exemplary embodiment of the present disclosure;

FIG. 19 is an exemplary view of an exemplary lighting control remote control device;

FIG. 20 is another exemplary view of an exemplary lighting control remote control device without any exemplary buttons, but illustrating an exemplary display screen, and/or touchscreen;

FIG. 21 is an exemplary remote control device, illustrating an exemplary user interface including a plurality of exemplary buttons and an exemplary display according to an exemplary embodiment of the present disclosure;

FIGS. 22A, 22B, 22C, and 22D illustrate other exemplary views of an exemplary remote control device according to an exemplary embodiment of the present disclosure;

FIG. 22E depicts an exemplary set of user interface buttons for an exemplary remote control device, according to an exemplary embodiment;

FIG. 23 is an exemplary isometric side view of an exemplary illuminance sensor illustrating a set of exemplary indicator(s) according to an exemplary embodiment of the present disclosure;

FIG. 24 is another exemplary isometric side view of the opposite side from FIG. 23, and illustrates an exemplary reset key/button, and an exemplary power input cable according to an exemplary embodiment of the present disclosure;

FIG. 25 is an exemplary blown up isometric view of the exemplary illuminance sensor, according to an exemplary embodiment of the present disclosure;

FIG. 26 is an exemplary partial cutaway isometric section view of the exemplary light sensor according to an exemplary embodiment of the present disclosure;

FIG. 27A is an exemplary isometric open perspective view of another exemplary light sensor according to an exemplary embodiment of the present disclosure;

FIG. 27B is an exemplary exploded view of the exemplary light sensor of FIG. 27A, including an exemplary stand and front face panel, according to an exemplary embodiment;

FIG. 27C is an exemplary front view of an exemplary light sensor, according to an exemplary embodiment;

FIG. 27D is an exemplary back side view of the exemplary light sensor, according to an exemplary embodiment;

FIG. 27E is an exemplary back side view of the exemplary light sensor, and exemplary power adapter, according to an exemplary embodiment;

FIG. 27F is an exemplary back side view of the exemplary light sensor, according to an exemplary embodiment;

FIG. 28 is an exemplary exploded view of an exemplary high bay lighting fixture illustrating an exemplary lens clear with a diamond face, according to an exemplary embodiment of the present disclosure;

FIG. 29 is an exemplary computer hardware architecture diagram according to an exemplary embodiment of the present disclosure;

FIG. 30 is an exemplary top, front, bottom, right and left side orthogonal front view, as well as an isometric bottom and top view of an exemplary rectangular LED troffer light, according to an exemplary embodiment;

FIG. 31 is another exemplary top, front, bottom, right and left side orthogonal front view, as well as an isometric bottom and top view of an exemplary narrow rectangular LED troffer light, according to an exemplary embodiment;

FIG. 32 is an exemplary top, front, bottom, right and left side orthogonal front view, as well as an isometric bottom and top view of an exemplary square LED troffer light, according to an exemplary embodiment;

FIG. 33 is an exemplary top, and bottom view, and cutaway cross-section of a canopy zigbee system of an exemplary square troffer, according to an exemplary embodiment;

FIG. 34 is an exemplary bottom view, and cutaway cross-sections of an exemplary canopy zigbee system of an exemplary square troffer, according to an exemplary embodiment;

FIG. 35 is an exemplary underside view of an exemplary square troffer, according to an exemplary embodiment;

FIG. 36 is an exemplary bottom view of an exemplary square troffer, according to an exemplary embodiment;

FIG. 37 is an exemplary top view of an exemplary highbay, according to an exemplary embodiment;

FIG. 38 is an exemplary underside view of an exemplary highbay when illuminated, according to an exemplary embodiment;

FIG. 39 is an exemplary exploded view of an exemplary highbay, according to an exemplary embodiment;

FIG. 40 is an exemplary underside view of an exemplary highbay, according to an exemplary embodiment;

FIG. 41 is an exemplary top view of an exemplary square troffer, according to an exemplary embodiment;

FIG. 42 is an exemplary underside view of an exemplary square troffer, according to an exemplary embodiment;

FIG. 43 is an exemplary underside view of an exemplary square troffer when illuminated, according to an exemplary embodiment;

FIG. 44 is an exemplary top view of an exemplary narrow rectangular troffer, according to an exemplary embodiment;

FIG. 45 is an exemplary underside view of an exemplary narrow rectangular troffer, according to an exemplary embodiment;

FIG. 46 is an exemplary underside view of an exemplary narrow rectangular troffer when illuminated, according to an exemplary embodiment;

FIG. 47 is an exemplary top view of an exemplary rectangular troffer, according to an exemplary embodiment; and

FIG. 48 is an exemplary underside view of an exemplary rectangular troffer when illuminated, according to an exemplary embodiment.

### DETAILED DESCRIPTION OF VARIOUS EXEMPLARY EMBODIMENTS OF THE DISCLOSURE

### Exemplary Embodiments

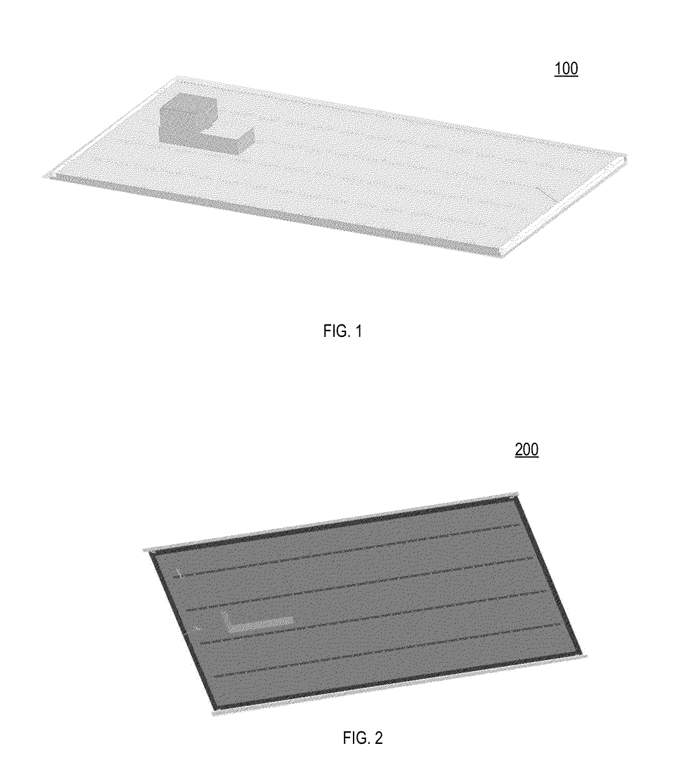

FIG. 1 is an exemplary isometric perspective view 100 of an exemplary troffer lighting apparatus, with exemplary communication and power driver components, according to an exemplary embodiment of the present disclosure.

FIG. 2 is an exemplary bottom orthographic view 200 of the exemplary troff lighting apparatus illustrating exemplary, but nonlimiting four (4) rows of exemplary light emitting diodes (LEDs), according to an exemplary embodiment of the present disclosure.

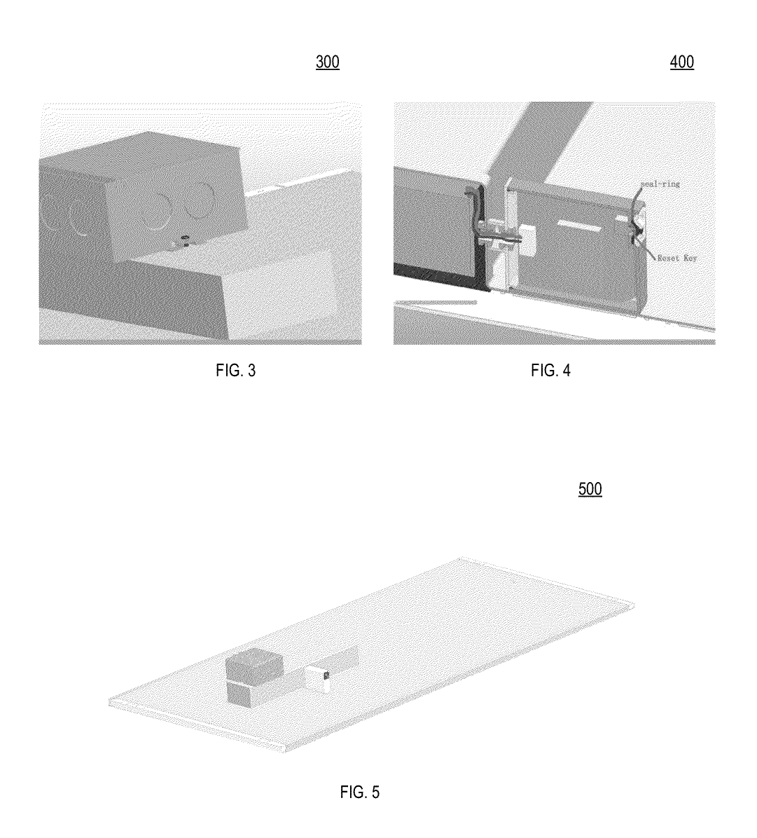

FIG. 3 is an exemplary top isometric view 300 of the exemplary troffer lighting apparatus, illustrating an exemplary junction box, coupled via exemplary couplers to an exemplary driver housing, which may include an airtight, airfree driver electronics with airspace filled with silicone to isolate the driver electronics, according to an exemplary embodiment of the present disclosure.

FIG. 4 is an exemplary partial cutaway isometric view 400 of an exemplary wireless receiver, illustrating an exemplary reset key and exemplary seal-ring according to an exemplary embodiment of the present disclosure.

FIG. 5 is an exemplary isometric top view 500 of the exemplary troffer lighting apparatus with an exemplary wireless transceiver illustrated coupled to the apparatus, which may be a Zigbee protocol compliant exemplary wireless receiver, according to an exemplary embodiment of the present disclosure.

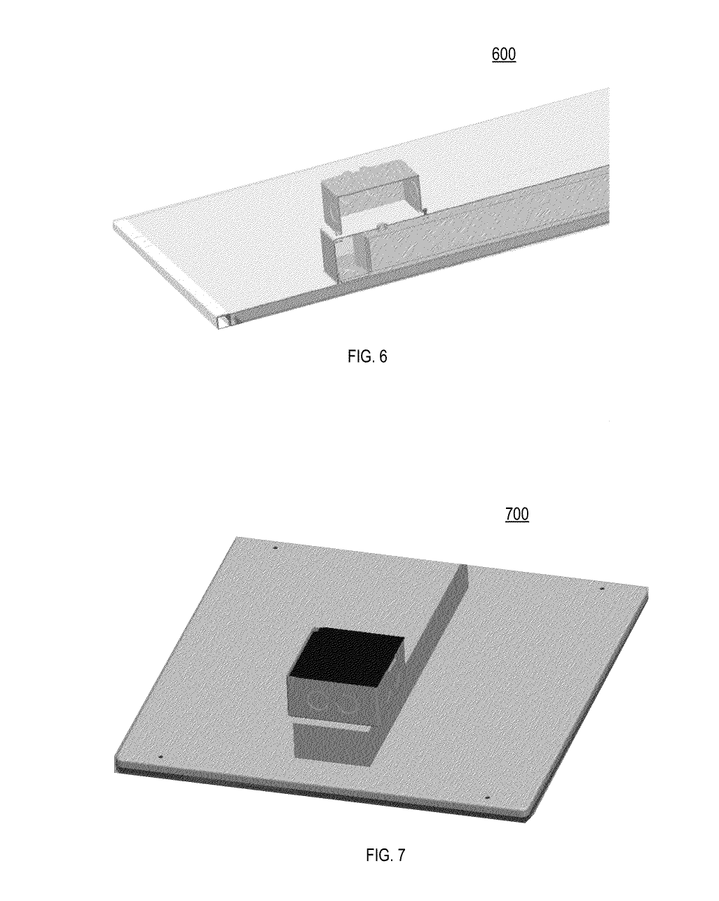

FIG. 6 is an exemplary partial cutaway isometric view 600 of an exemplary troffer lighting fixture with an exemplary motion sensor, and an exemplary junction box according to the exemplary embodiment of the present disclosure.

FIG. 7 is an exemplary isometric perspective top view 700 of an exemplary canopy lighting fixture with an electrical junction box atop it, according to an exemplary embodiment of the present disclosure.

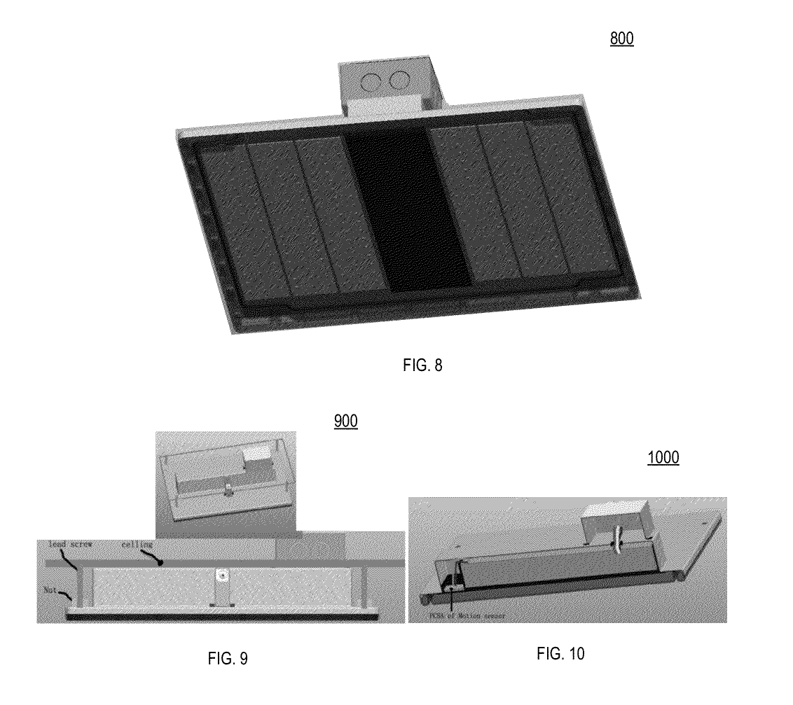

FIG. 8 is an exemplary bottom isometric view 800 of the exemplary canopy lighting fixture including a plurality of LED plates each with an exemplary plurality of LED modules, each with a substantially narrow candle socket candle LED light bulb according to an exemplary embodiment of the present disclosure.

FIG. 9 is an exemplary front side and isometric view 900 illustrating an exemplary assembly method of the exemplary canopy light fixture illustrating a lead screw, nut and ceiling, according to an exemplary embodiment of the present disclosure.

FIG. 10 is an exemplary side isometric view 10000 of the exemplary canopy illustrating an exemplary motion sensor location and exemplary junction box according to an exemplary embodiment of the present disclosure.

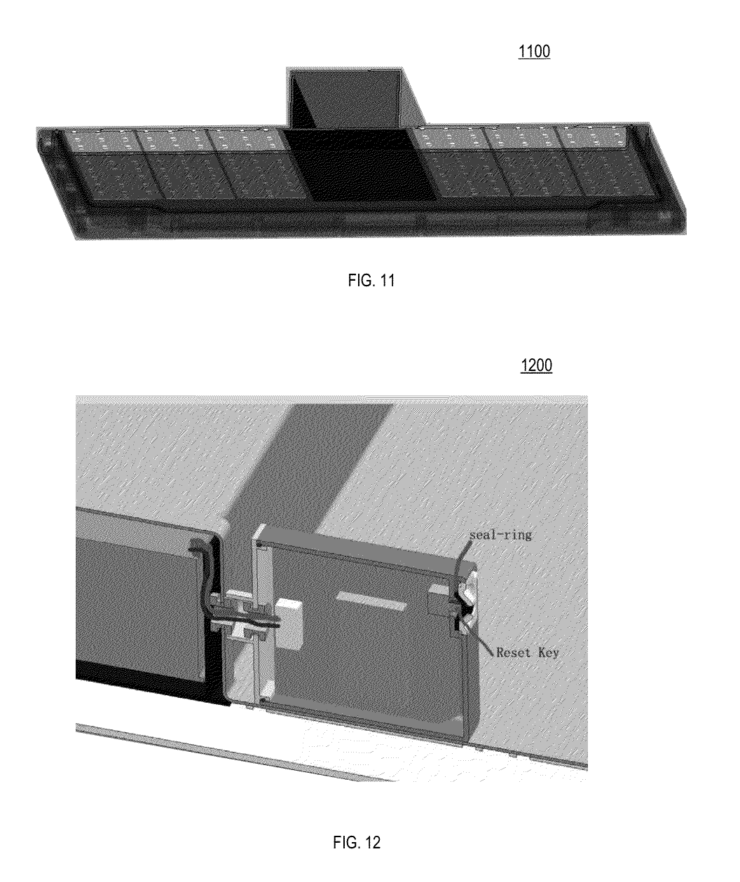

FIG. 11 is an exemplary bottom isometric view 1100 of the exemplary canopy light fixture illustrating various exemplary rectangular LED plates each with an exemplary plurality of LEDs, according to an exemplary embodiment of the present disclosure.

FIG. 12 is an exemplary partial cutaway isometric view 1200 of the exemplary canopy lighting fixture illustrating an exemplary zigbee wireless transceiver module, including an exemplary zigbee transceiver location with an exemplary reset key and exemplary seal-ring, configured to seal out moisture in damp locations, according to an exemplary embodiment of the present disclosure,

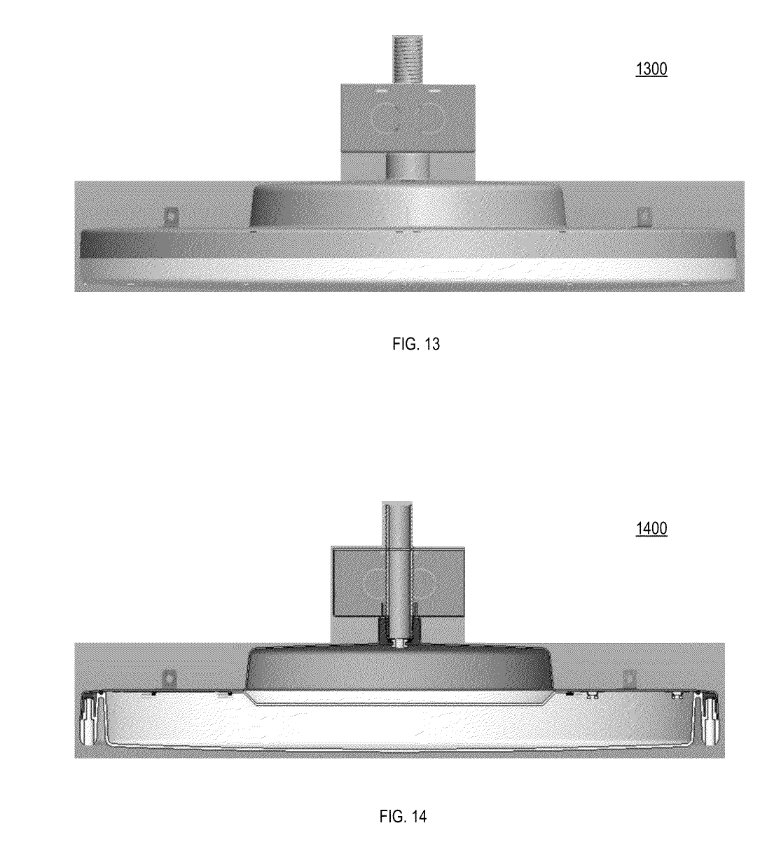

FIG. 13 is an exemplary front side orthographic view 1300 of an exemplary high bay lighting fixture illustrating from the top an exemplary wiring conduit, leading to a dedicated electrical junction box, then to wireless transceiver and the metal housing, according to an exemplary embodiment of the present disclosure.

FIG. 14 is an exemplary cross-sectional partial cutaway front orthographic view 1400 of the exemplary high bay lighting fixture according to an exemplary embodiment of the present disclosure.

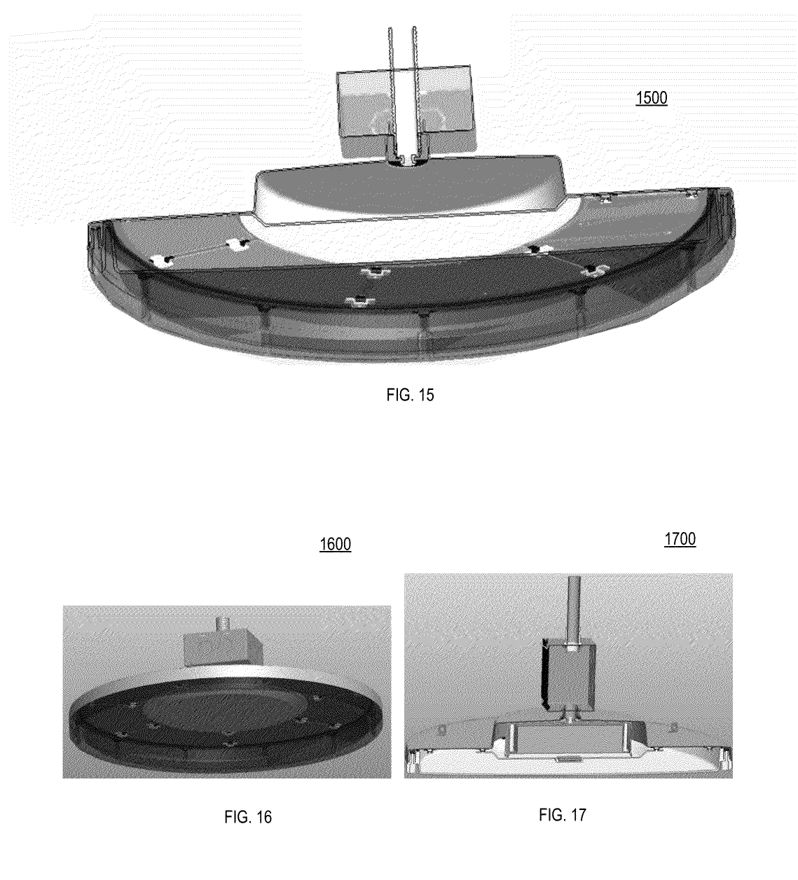

FIG. 15 is an exemplary side orthographic semi cutaway view 1500 of the exemplary high bay lighting fixture according to an exemplary embodiment of the present disclosure.

FIG. 16 is an exemplary bottom isometric view 1600 of the exemplary high bay lighting fixture illustrating a plurality of exemplary LED plate sector portions of an exemplary annular ring according to an exemplary embodiment of the present disclosure.

FIG. 17 is an exemplary side cutaway view 1700 of an exemplary high bay lighting fixture according to an exemplary embodiment of the present disclosure.

FIG. 18 is an exemplary isometric top view 1800 of the exemplary highbay lighting fixture illustrating an exemplary location for an exemplary wireless transceiver according to an exemplary embodiment of the present disclosure.

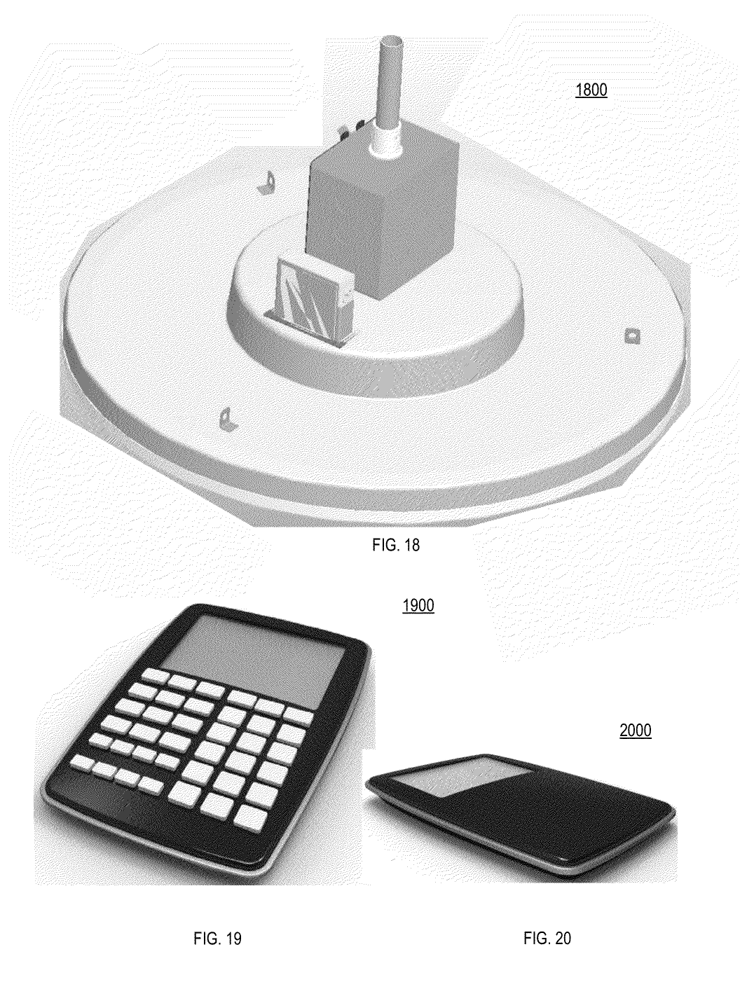

FIG. 19 is an exemplary view 1900 of an exemplary lighting control remote control device.

FIG. 20 is another exemplary view 2000 of an exemplary lighting control remote control device without any exemplary buttons, but illustrating an exemplary display screen, and/or touchscreen.

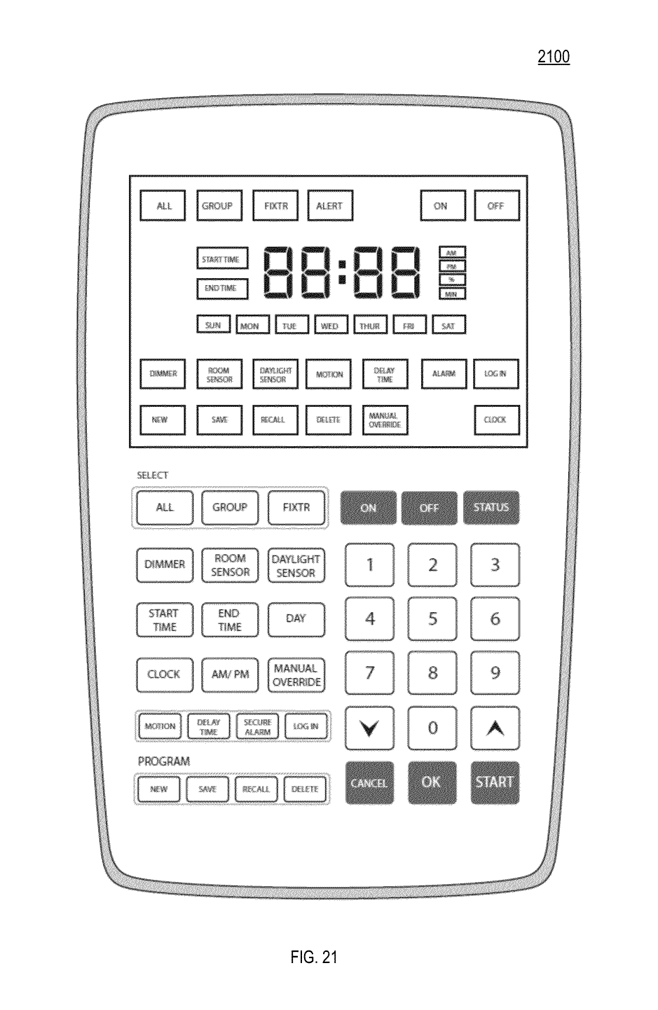

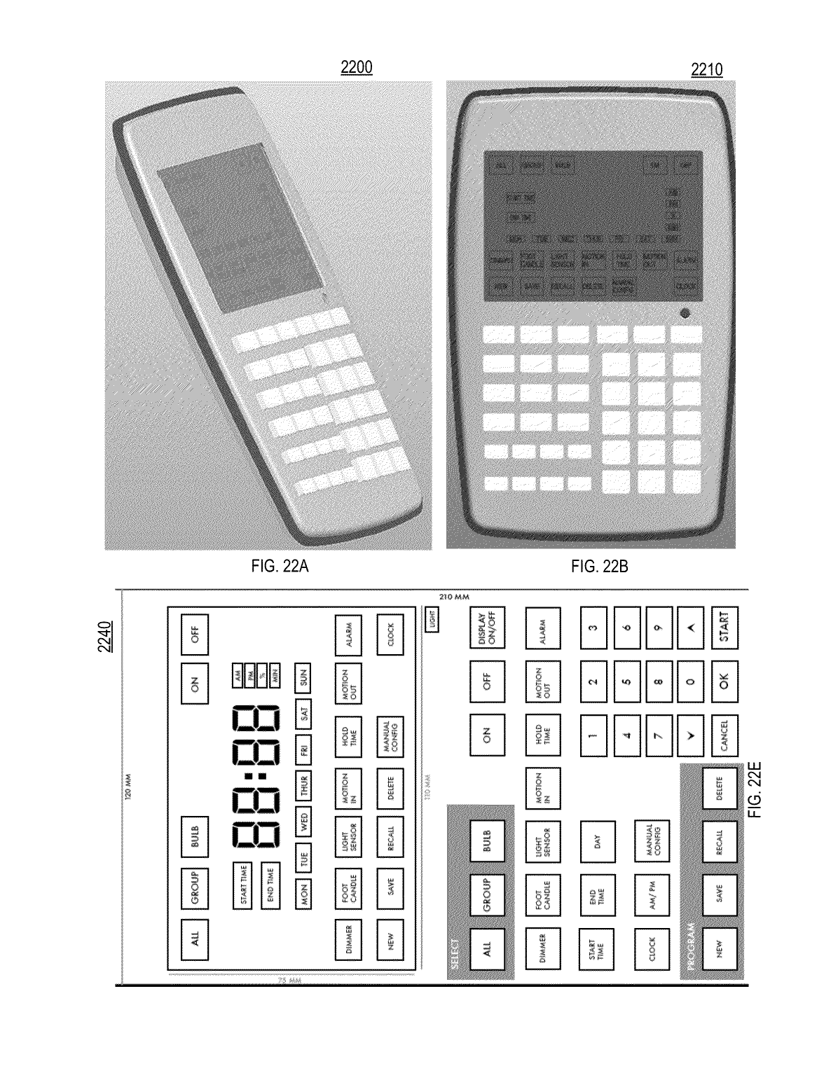

FIG. 21 is an exemplary view 2100 of an exemplary remote control device, illustrating an exemplary user interface including a plurality of exemplary buttons and an exemplary display according to an exemplary embodiment of the present disclosure.

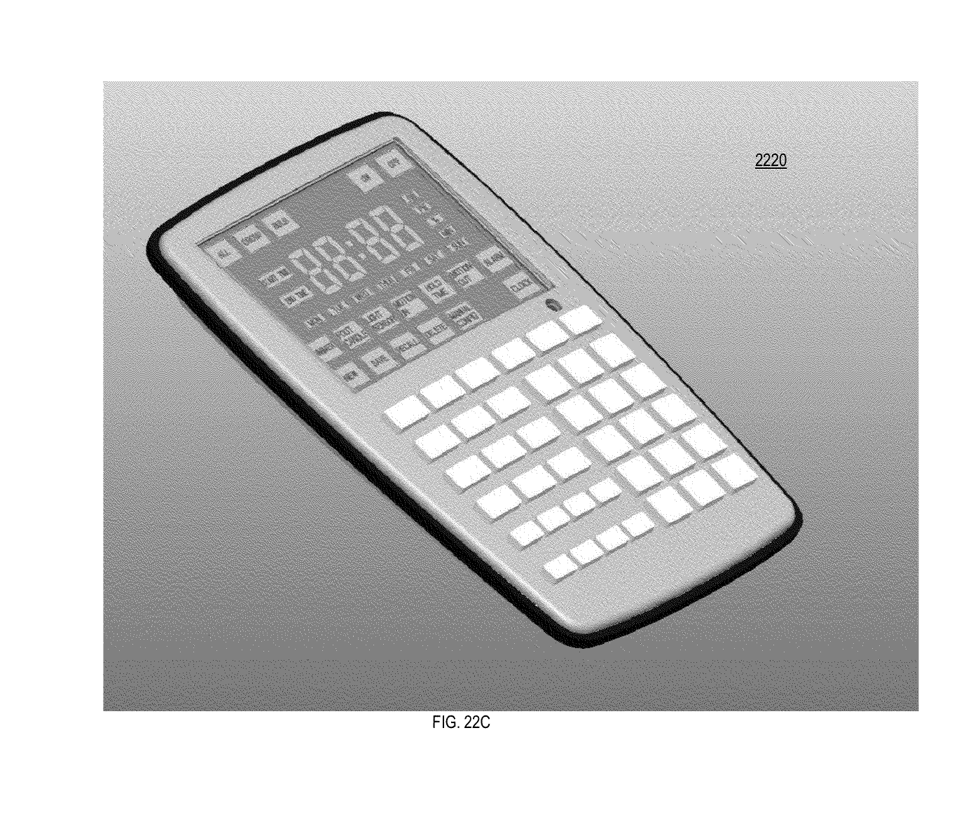

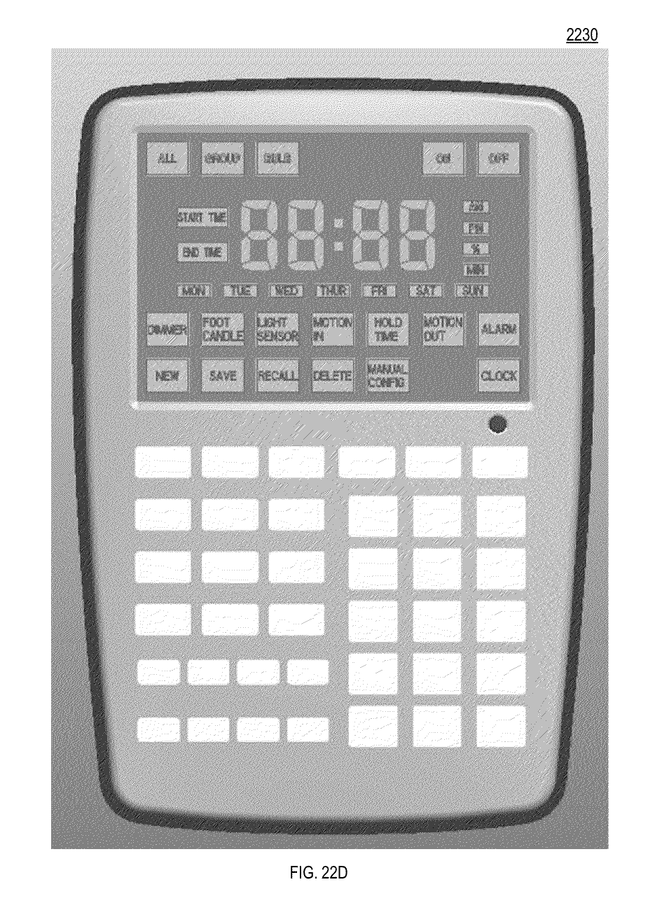

FIGS. 22A, 22B, 22C, and 22D illustrate other exemplary views 2200, 2210, 2220, 2230 of an exemplary remote control device according to an exemplary embodiment of the present disclosure.

FIG. 22E depicts an exemplary view 2240 set of exemplary user interface buttons for an exemplary remote control device, according to an exemplary embodiment.

FIGS. 22A-22E (collectively FIG. 22) depicts an exemplary remote control including an exemplary display and/or touchscreen and/or user interface, according to an exemplary embodiment, which may be coupled via an exemplary wireless communications network to control one or more of the exemplary LED bulbs according to an exemplary embodiment.

Exemplary remotes may include lighting controls, which may, according to an exemplary embodiment, e.g., but not limited to, permit lighting control, based on e.g., sensors, so that dimming may automatically be controlled, based on level of daylight, etc., and the controller may adjust to compensate for more or less daylight.

Exemplary daylight sensors may be wall and/or window mountable.

An exemplary daylight sensor, which may also be referred to as an exemplary broad range light sensor, may measure light in the range of an exemplary 200 lux to 10,000 lux, according to an exemplary embodiment.

An exemplary illuminance sensor, which may also be referred to as an exemplary narrow range light sensor, or roomlight sensor, may measure light in the range of an exemplary 100 lux to 2,000 lux, according to an exemplary embodiment.

According to an exemplary embodiment, the sensors may be equipped to communicate with controllers via, e.g., but not limited to, wireless communications such as, e.g., but not limited to Zigbee wireless communication, according to an exemplary embodiment. Exemplary light and/or illuminance sensors may include, e.g., but not limited to, an exemplary one or more LED indicator(s), which may indicate power on/off, power failure, etc., and/or other output devices, and may include e.g., a reset button (e.g., paperclip resettable, push in to reset, etc.), and/or switch, and/or other input devices, and the sensor may include an exemplary programmable microcontroller and/or microprocessor, or other chip and/or communications hardware/firmware/and/or software stack, may include communications chip capability, to communicate with/via a wireless transceiver to an exemplary wireless gateway via exemplary Zigbee protocol, and/or other communications methods as are well known such as, e.g., but not limited to, Bluetooth, Wi-Fi, Wi-Max, UWB, Spread Spectrum, Broadband over powerline (BPL), cableTV (CATV) modulation, etc., as well as, exemplary power input, and/or may include sensing a range of levels such as, e.g., but not limited to, a 0-9 level of 10% increments, and/or a 0-99 level of 1% increments, which may be transmitted to the controller from the exemplary sensor, according to an exemplary embodiment. The unit may be a hanging, desk mount, and/or wall mount and may include an exemplary disk shaped sensor, which may include an exemplary polycarbonate disk or other protector for the sensor, according to an exemplary embodiment.

Exemplary LED bulbs and/or lighting fixtures may be outfitted with exemplary wireless communication transceivers permitting wireless control of the bulbs and/or fixtures. Exemplary embodiments may include an IEEE 802.15.4 wireless transceiver compliant in an exemplary embodiment with the Zigbee protocol. Various exemplary fixtures may include exemplary pulse wave modulation (PWM) controllable dimmer driver circuits, which according to an exemplary embodiment may permit dimming in 1% increments from 0% to 100%, according to one exemplary embodiment. According to an exemplary embodiment, a power driver may be able to convert 120V or 277V AC current to 10-18 V DC current in the exemplary driver. Driver housings, according to an exemplary embodiment may be completely filled with silicone to permit isolating electronic components from exemplary metal housing, or other components, to reduce or eliminate risk of shock from unintended short circuits.

An exemplary wireless communication adapted apparatus may be configured to upon power up send out a registration of its address to register itself with a wireless gateway. An exemplary 12 inch cord with an electrical plug on one end may be used to register a device, and then after registration by powerup by plugging into an outlet, the cord may be unplugged from the device and the device may then be ready for final install.

An exemplary ethernet gateway may include an ethernet port for coupling to an ethernet router, and may support up to an exemplary 600 units to 20,000 units to allow communication/control of the various lighting apparatuses via wireless control using the Zigbee protocol, e.g., IEEE 802.15.4, or the like, etc.

Alternative embodiments may use other protocols such as, e.g., but not limited to, Wi-Fi, Wi-Max, BlueTooth, and/or other wireless communications protocol, as will be apparent to those skilled in the relevant art.

Certain devices may be provided with a reset button on an exemplary apparatus or fixture, permitting reset of an exemplary apparatus or fixture.

Certain exemplary fixtures may be provided for commercial use including, e.g., but not limited to, a troffer, a troffer hung by chain or pin, a high bay, a low bay, a canopy version, a chained or pendant version, down lights, down lights in a custom can or a kit in a standard off the shelf downlight can, etc., according to an exemplary embodiment.

Certain versions may be adapted for use in humid environments, such as, e.g., but not limited to, misting rain, blowing snow, food processing plants, gas stations, etc., by including exemplary sealing rings.

Certain versions may include an exemplary diecast steel and/or other sheetmetal housing, may include an exemplary hole in the exemplary housing through which an electrical conduit may pass through, an exemplary junction box which may include space to permit coupling the lighting device to the exemplary fixture. the exemplary fixture may include a heat dissipater, an exemplary cylinder housing portion for housing an exemplary driver circuit, one or more LED plates, such as, e.g., but not limited to, four (4) and/or 6 sector shaped partial annular ring shaped plates surrounding an exemplary high bay and/or low bay, each of the exemplary LED plates with a plurality of LED plates thereon, an exemplary lens such as e.g., an exemplary polycarbonate exemplary clear and/or frosted lens, with an exemplary A12 pattern exemplary diamond shaped prism, and exemplary bottom fixture which can protect the LEDs modules from being contacted by water and/or other liquids. Exemplary LED plates may be ceramic plates, which may be a wafer with LEDs mounted to the wafer.

Exemplary residential LEDs may be provided with a warm 3000 kelvin color, while an exemplary commercial light may include an exemplary 4000 kelvin cool white color, according to an exemplary embodiment. Further, exemplary lighting fixtures may include a color rating index (CRI) of about 780, a measure of how well the lighting fixture will maintain its color over the life of the lighting device, approximately 86-88, and potentially 90 or greater, according to an exemplary embodiment.

An exemplary troffer light may be approximately 2 feet by 4 feet rectangular in exemplary shape with exemplary 5000 or 8000 lumen versions for recessed troffers, according to an exemplary embodiment, or 8000-14000 lumen exemplary versions for chain or pin hung troffers.

An exemplary canopy light may include an exemplary 2 feet by 2 feet and approximately 5,000 or 8,000 lumen versions, according to an exemplary embodiment.

An exemplary low bay light may be about 20 inches in diameter, in an exemplary embodiment, and an exemplary approximately 14,000 lumens.

An exemplary high bay may be approximately 24 inches in diameter, i.e., about 3-4 inches greater in diameter than an exemplary low bay, and may support an approximate 18,000-26,000 lumens, etc., according to an exemplary embodiment.

Exemplary downlight embodiments may include, e.g., but not limited to, 600 lumen, 1000 lumen, 1400 lumen, and/or 4 inch and/or 6 inch version kits, which may include a piece including an exemplary trim, lens, LED, and driver, according to an exemplary embodiment. An exemplary embodiment may support an adapter to screw into a socket, and the kit may be placed into a remarked can from various vendors. An exemplary downlight may include a DLC and/or Energy Star compliant versions.

FIG. 21 depicts an exemplary remote control including an exemplary display and/or touchscreen and/or user interface and/or optional buttons and/or optional keys, according to an exemplary embodiment, which may be coupled via an exemplary wireless communications network to control one or more of the exemplary LED bulbs according to an exemplary embodiment.

An exemplary illustration of how the remote control can communicate with the Lamp system and device may be illustrated by an exemplary block diagram comprising:

1) remote<---->wireless<---->zigbee LED device<---->wireless transceiver<---->LED controller to control LED(s)

2) wifi smartphone remote<---->wireless (e.g., WIFI, Bluetooth, etc.)<---->wifi router<---->gateway<---->LED device wireless transceiver<---->LED controller to control LED(s)

An exemplary algorithm may include the following:
Remote On/Off-->Jenny 4/4/14: Display On/Off

Wake up remocon from safe mode. If no touch key button for 60 sec, the remocon will go into safe mode, and LCD & light signal will off. If user needs to use remocon, he must press Display On/Off key, and then remocon works. Otherwise, other keys are not effective.

Press Display On/Off, signal lights is green, and LCD display current clock.

100%

100%

“Power”

Remark:

If turn on bulbs by wall switch, all bulb shall be 100% On.

If turn off bulbs by wall switch, all bulb shall be 100% Off.

After wall switch is on, and then “Display On/Off” remocon, bulbs will perform the program (if has) as it was setup for current time until wall switch is off
ALL:

ALL START,

To choose All bulbs.

Ex. Press All, and press Start, then all bulbs will be on.
GROUP:
GROUP, START, (100%)

[symbol]

To choose group.

Ex. Group->number->Start. This group will be 100% on.
BULB:
30
Bulb->2->Bulb->3->Off. 2 3
Bulb->2->OK->Bulb->3->Off

To choose bulb.

Ex. Bulb->2->Bulb->3->Off. Then bulb 2&3 will be off.
Or, Bulb->2->OK->Bulb->3->Off. Bulb 2&3 will be off.
START TIME:
Set up start time for certain function.
END TIME:
Group->5->Start Time->Day->2->OK->08:00->AM->End Time->Day->2->10:30->AM->Start, 8, 10:30, 100%

[symbol]

Set up end time for certain function.

Ex. Group->5->Start Time->08:00->AM->Day->2->OK->End Time->10:30->AM->Day->Day->OK->Start, then group 5 will be 100% On during Tuesday 8:00 am˜10:30 am.

Jenny 4/4/14: If you pressed “Start time” or “End Time” button, then you need to enter the number of time as above. After that, we can press “Day” or Function button. If you pressed “Day” first, then choose day and then press “Start or End time”.

100%
If no input day, but input start time & end time, then default as every day from start time to end time.
If no input time, but input day, then default as 00:01 am˜11:59 pm at that day.
If input start time & day, and input end time, no day, then default as start time to end time at same day as input.
If no input function, then default 100% dimming.
If input function, then perform as it's set up.
DIMMER:
1˜100% [symbol] 100% [symbol]
: Group->3->Start Time->Day->2->OK->08:00->AM->End Time->Day->Day->OK->10:30->AM->Dimmer->80->Start. 8:00 10:30 80%.

Set up the dimming percentage, 1˜100%. Default is 100%.

Ex. Group->3->Start Time->08:00->AM->Day->2->OK->End Time->10:30->AM->->Day->Day->OK->Dimmer->80->Start. Then group 3 will be 80% on during Tuesday 8:00 am˜10:30 am.
FOOT CANDLE:

200′ 400′ 600′ 800′ 1200′ 1400′ 1600′ 1800′ 2000, 2000 [symbol]
LIGHT SENSOR:

1˜100, 100 1˜100 10

: Group->8->Light Sensor->20->Start.

20 0 100%, 0%

[symbol]

Determine whether to turn on/off the bulbs. Set up 1˜100. Default is 100. 10 is darkest, 100 is brightest. 1˜100 means brightness lever, not actual brightness. Totally user can choose 10 levers, every 10 for 1 lever. So option 10, 20, 30, 40, 50, 60, 70, 80, 90, 100.

Ex. Group->8->Light Sensor->20->Start. Then group 8 will be 100% ON when light sensor sensed the brightness is less than 20's level, group 8 brightness is turned from 0˜100% gradually in 10 seconds. If the light sensor sensed the brightness is more than 20's level, then group 8 will be off from 100% to 0% gradually, in 10 sec.
Motion in, Motion out, Hold Time
100%

: Group->7->Motion in->90->Hold Time->10->Motion out->30->Start. 90%, 10 30% [symbol]
Group->7->Motion in->Start. 100%,

When motion sensor sensed anybody or car moved in, then bulb will be ON, default dimming 100%, default time is 5 minutes. When it cannot sense any movement for 5 minutes, default as Off, or operate as program.

Ex. Group->7->Motion in->90->Hold Time->10->Motion out->30->Start. Then, if anybody/car walked in group 7 area, all bulbs of group 7 will be 90% on. After it cannot sense any movement in 10 minutes, group 7 will be Off (or operate as programmed).

Jenny 4/4/14: How about the “Motion out->30”? It sensed after 15 min. from the hold time, how does work?

it should be 30% on from the motion out or 90% on from the motion in?
Clock
Clock->08:00->AM->Day->3->Start. 8

Clock

Set up current clock.

Clock->08:00->AM->Day->3->Start. Then current clock is Wednesday 08:00 am.

User has to input time first and then day. 4 digits of LCD will be blinking when you press “Clock” button.

Clock information will be sent and stored in gateway once it's setup.
AM/PM
AM/PM, START

Set up AM/PM
DAY

Day+1=

Day+2=

Day+Day=

Day+1+2+3+4+5,

Day+1+Day+2+Day+3+4+Day+5 Day+1+2+3+4+5+2+4,

“Day”, 1, OK, Mon [symbol] [symbol] Mon [symbol] , [symbol] , [symbol] Mon

[symbol]

Set up day.

Day+1=Monday

Day+2=Tuesday

Day+Day=Tuesday

Day+1+2+3+4+5, or Day+1+Day+2+Day+3+4+Day+5, then Mon˜Fri are selected.

Day+1+2+3+4+5+2+4, then only Monday, Wednesday and Friday are selected. Double selected day will disappear.

If you press “Day”, then “Mon” will be blinking. If you press 1 or press “OK”, then choose Mon. After choose Monday, Press “1” again then “Mon” will disappear.
New
100

Make program. Minimum, user is able to input 100 pcs of program.
Save
25

New->Object->Time (Day->Time, or Time->Day)->Function->Save->number->save.

Off

Save program

New->Object->Time (Day->Time, or Time->Day)->Function->Save->number->save.

If no choose object, then default as All.

If no choose Time, then default as from now, until anybody changes it.

If no choose function, then default as “OFF”

In each program, max user can setup 25 pcs of functions at the same time.
RECALL
Recall->5->Start.

Recall->5->OK. Save->any number->Save. Delete

Save->29->Save, 29

Save->29->Save->Start, 29

Delete

Save

Save->29, Delete,

Save->29->Save, Delete, 29

Display/revise/start program which already been saved.

Recall->5->Start. Execute program 5.

Recall->5->OK. Display program 5. According to displayed program, user can revise it. After revision, press Save->any number->Save. User can quit this revision by press Delete.

Jenny 3/25/14: “any number”-->If you press “5” then it will be over writing the program.
If you press any other number than “5” then, it will be save as a new program.
And it will be kept Program 5 as original setting.
Example) Recall->5->OK-->Changed function->Save->5->Save
   Saved with changed function at the Program 5.
   Recall->5->OK-->Changed function->Save->29->Save
   Saved with changed function at Program 29 and also keep the program 5 as original setting without any changed function.
Recall->5->OK-->Changed function->Save->29->Save->Start
If you press “Start” button after changed & saved program, then “program 29” will be executed.

“User can quit this revision by press Delete-->This Delete key should be works before press 2nd time of “Save” button, which means “Save”->5->Delete: it should be worked.

However, it should not be worked after press second time of “Save” button. Which means “Save”->5->Save->Delete: it should not work.

“Recall”, “G4”

P005.

All, Group, Bulb [symbol] G001, G002, B001, B002

LCD
When you press “Recall”, “G4” will be blinking
Then it display program# like P005.
Then it display object, like “All”, or “Group”, or “Bulb”, and selected objected # will be displayed as like G001, G002, or B001, B002 etc. display will change every 1 sec.
Then it display function.
LCD changes display for each stage by 5 sec.
If you press arrow at any time during changes display, then can go back and force.
If you didn't press arrow or any other order within 15 sec, it will go back to show automatically.
Program modification, can only modify number information, cannot modify, delete or add function.
DELETE
DELETE

DELETE, OK,

Delete the program.

Ex. Delete->5 (already saved this program before)->Delete->OK. Then this program will be deleted.

New->All->Start Time->Day 2->0800 am->Auto In->Save->5->Delete,

Group->5->Light sensor->Delete,

[symbol] New->All->Start Time->Day 2->0800 am->Auto In->Save->5->Save->Delete, 5

Delete->5->Delete->OK. 5
Group->5->Light sensor->Start,

Cancel all previous input.

Ex. New->All->Start Time->0800 am->Day 2->Auto In->Delete, then all input will be cancelled.

Group->5->Light sensor->Delete, then all input will be cancelled.

New->All->Start Time->0800 am->Day 2->Auto In->Save->5->Save->Delete, then previous input cannot be cancelled. This program has been saved as program 5. If user need to delete the program 5#, he has to press Delete->5->Delete->OK.

Group->5->Light sensor->Start, then previous input cannot be cancelled, because this order has been sent out.

20′ ALARM
ALL START TIME, END TIME, ALARM, START,

Bulbs turn on 100% On when motion sensor detected movement.

Ex. All->Start Time->0800->PM->Day->OK->End Time->0700->AM-Day->2->OK->Alarm->OK. Then if anybody breaks in during Monday 08:00 pm to Tuesday 07:00 am, if any motion sensor sensed movement, all bulbs will be 100% on.

Jenny 3/25/14: Depends on “Day” function on page 2.

22′ CANCEL
CANCEL

Cancel the input.

Press one time “Cancel”, cancel last one input.

Press twice “Cancel”, cancel last two input.

23. Manual Config.

Manual Config. Manual Config. Manual Config. Manual Config.

Press Manual Config., and it enters into manual function.

If it's already Manual Config., and press “Manual Config.”, it will quit Manual Config. and returned to auto mode as default mode.

“Manual Config.” 5,

All->Motion in->Start. “Motion in”

“Manual Config.”, 5.

Remark:

As default, it operates as auto mode. Auto mode is running program only.

After switch into Manual Config., it operates as manual input order only.

Therefore, in case you're running program 5 now, and you switched to Manual Config., and input All->Motion in->Start. Then all bulbs will be under “Motion in” function until somebody gives new order to it (or wall switch is off). And after you press “Manual Config.” again, it will return to auto mode, and runs program 5.

5# (all light sensor 70), Group 3, Off, Group3

If all bulb are running program 5# (All light sensor 70), then user enter into manual config, and order Group 3->Off, then group 3 will be off immediately, until it receives new manual order, or user quit manual config, or user power off wall switch and then power on wall switch. other bulbs will still run program 5 (light sensor 70).
On

### On

Turn on bulbs.

Object->Time->On.

Then the chosen bulbs will be on.

If no input object and time, then default as turn on all bulbs immediately, until somebody orders other function. Or power off wall switch.

Off

Off

Off

Object->Time->Off.

Then the chosen bulbs will be off.

If no input object and time, then default as turn off all bulbs immediately, until somebody orders other function. Or power off wall switch, and then turn on.

100

50

24

4

5′ 24 Off

6′ 25

7′ PC

PC 8′ USB 9′ Clock

12′

13′ Foot candle Dimming [symbol] , Foot candle

14′ Foot candle light sensor

[symbol]

15′ candle foot candle 100%

16′ All->Motion In->Foot Candle 80->Start.

foot candle 80

[symbol]

Remark
Gateway can save minimum 100 pcs program.
Due to limitation of gateway memory, user can make max 50 groups.
Program input order: object+time (day, time or time, day)+function. If no day input, then default as Monday to Sunday; if no time input, then default as 24 hrs. if no day & no time input, it will be repeated Monday to Sunday as 24 hrs every day.
User is supposed to set up all function in all day long for 24 hrs and 7 days. if user forgot to set up function in certain period, then default it as off
At the same time, max input bulb/group number is 30 pcs.
In one program, max can input 25 pcs of function.
Only in PC, user can setup network, bulb read, bulb rename and group. And user can change bulb name or group in PC anything they want.
Remocon will use dry battery, which users shall purchase by themselves. No USB cord will be used on remocon.
In gateway, button battery will be used to backup clock. If clock is incorrect in remocon, user can set up by Clock key, and gateway's clock information will be renewed once it's setup in rermocon.
The gateway data will not lose even though it's power off suddenly.
All data shall be stored in IC of gateway, as long as IC in gateway works normal, all data is alive. User should be able to unsoldering the IC and apply it to another gateway to continuously use.
No switch in gateway.
User cannot setup foot candle & dimmer at the same time. If setting at the same time, foot candle has priority.
User cannot setup foot candle & light sensor at the same time.
When it's running foot candle function, if foot candle suddenly doesn't work, then the chosen bulbs will be default as 100% on.
All->Motion In->Foot Candle 80->Start. Means, when people/car moves in, all bulbs will run as foot candle 80.

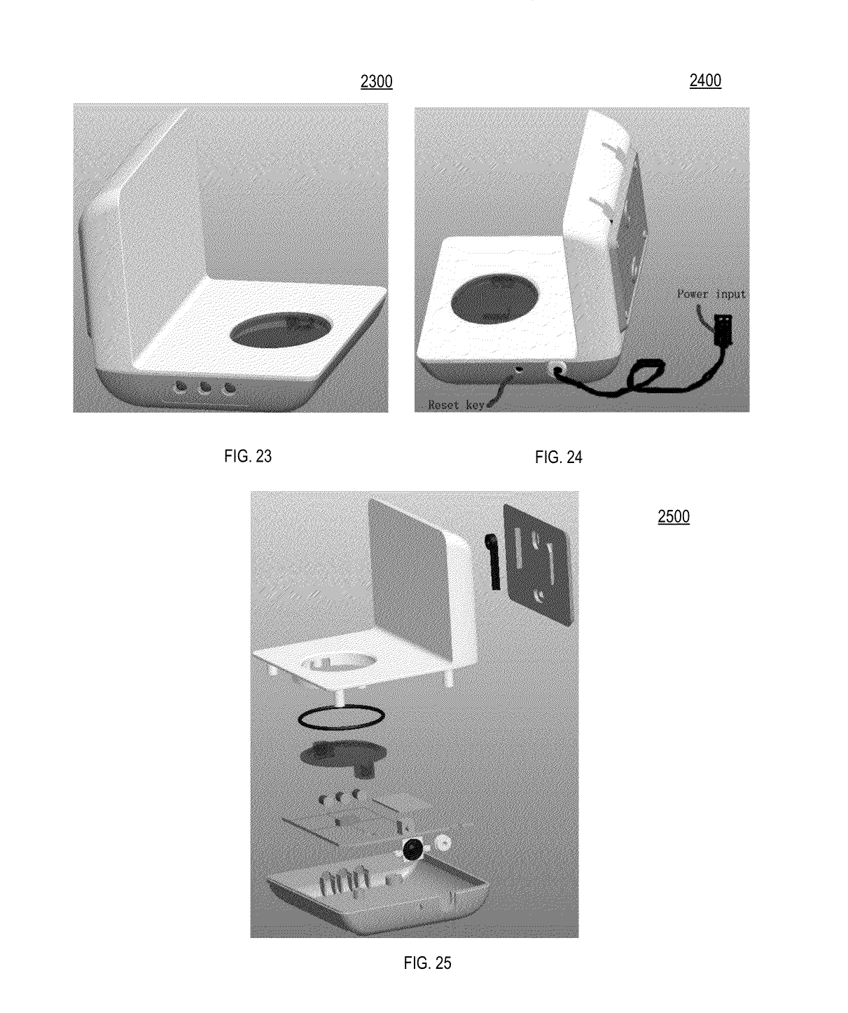

FIG. 23 is an exemplary isometric side view 2300 of an exemplary illuminance sensor illustrating a set of exemplary indicator(s) according to an exemplary embodiment of the present disclosure.

FIG. 24 is another exemplary isometric side view 2400 of the opposite side from FIG. 23, and illustrates an exemplary reset key/button, and an exemplary power input cable according to an exemplary embodiment of the present disclosure.

FIG. 25 is an exemplary blown up isometric view 2500 of the exemplary illuminance sensor, according to an exemplary embodiment of the present disclosure.

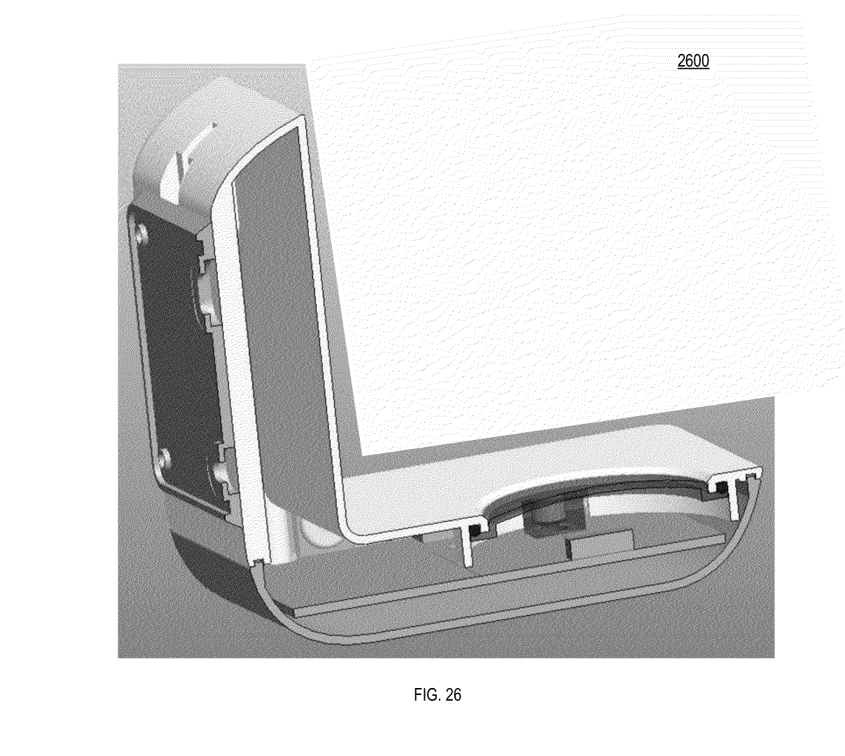

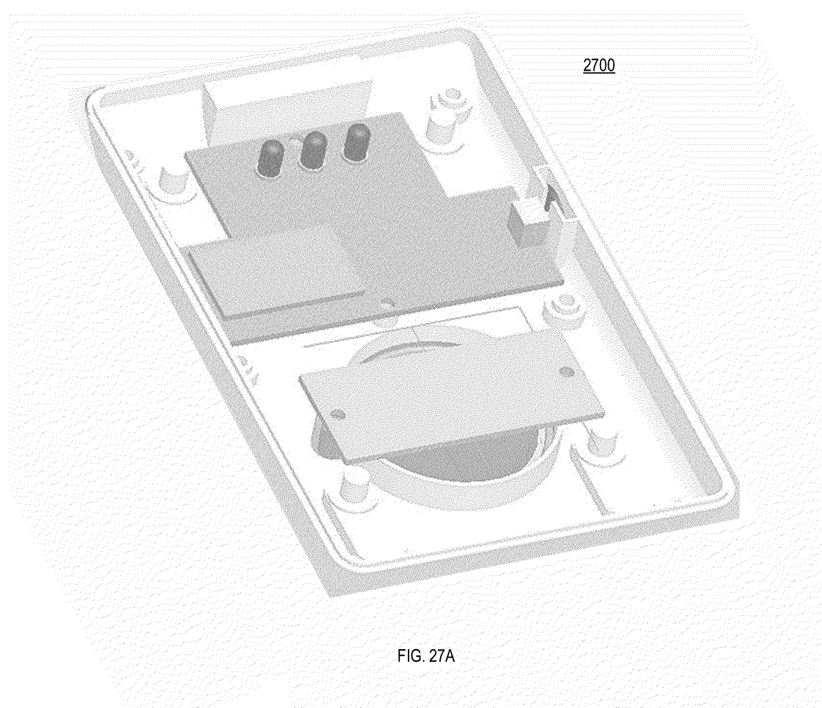

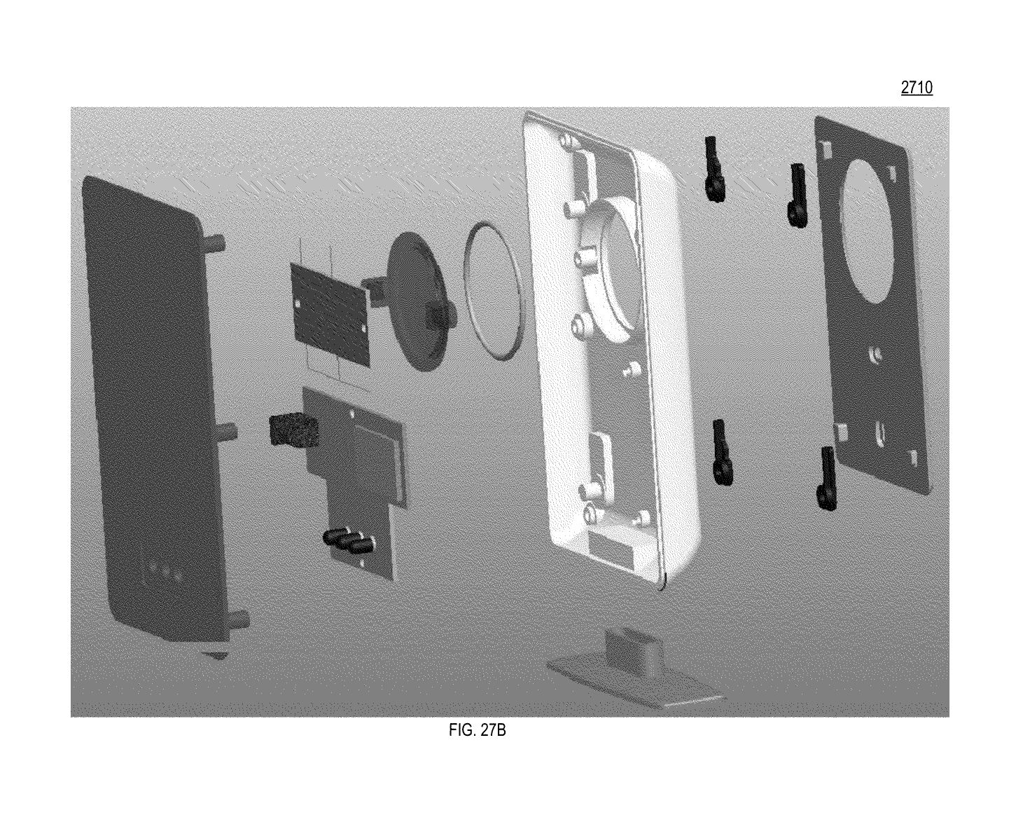

FIG. 26 is an exemplary partial cutaway isometric section view 2600 of the exemplary light sensor according to an exemplary embodiment of the present disclosure.

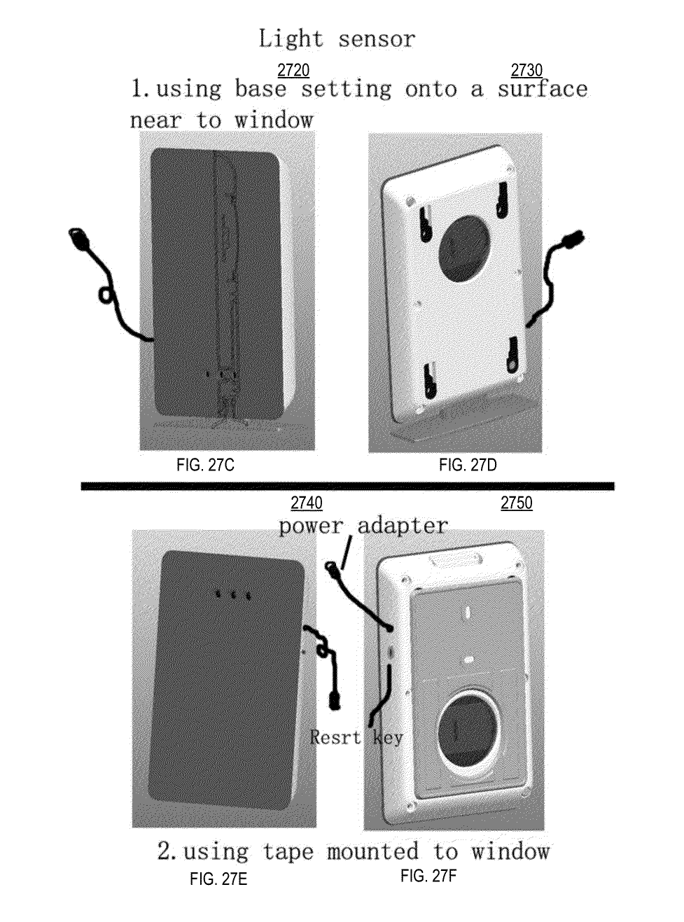

FIG. 27A is an exemplary isometric open perspective view 2700 of another exemplary light sensor according to an exemplary embodiment of the present disclosure.

FIG. 27B is an exemplary exploded view 2710 of the exemplary light sensor of FIG. 27A, including an exemplary stand and front face panel, according to an exemplary embodiment.

FIG. 27C is an exemplary front view 2720 of an exemplary light sensor, according to an exemplary embodiment.

FIG. 27D is an exemplary back side view 2730 of the exemplary light sensor, according to an exemplary embodiment.

FIG. 27E is an exemplary back side view 2740 of the exemplary light sensor, and exemplary power adapter, according to an exemplary embodiment.

FIG. 27F is an exemplary back side view 2750 of the exemplary light sensor, according to an exemplary embodiment.

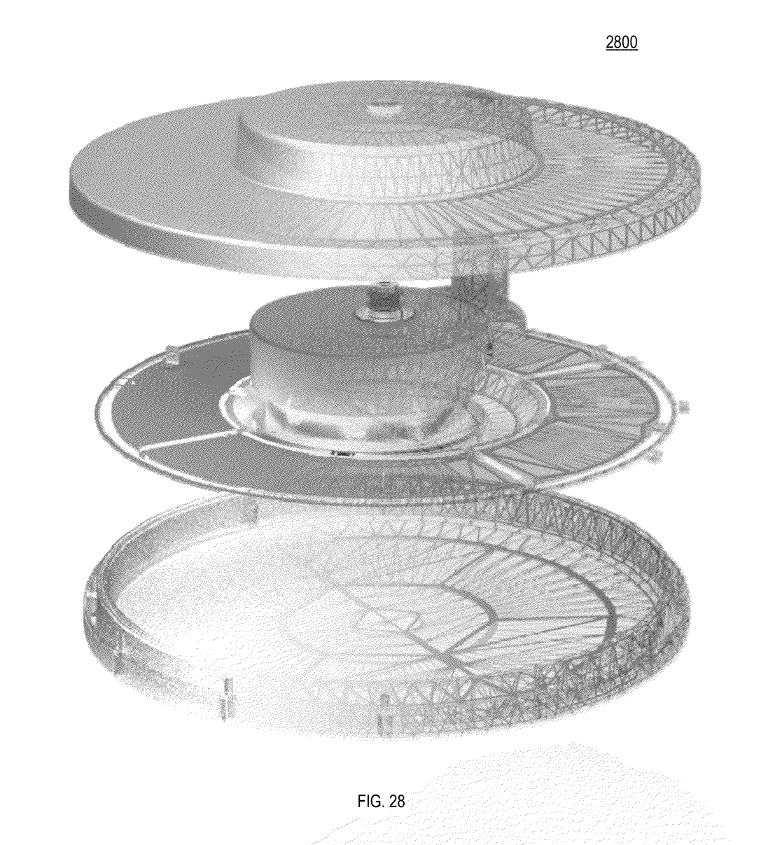

FIG. 28 is an exemplary exploded view 2800 of an exemplary high bay lighting fixture illustrating an exemplary lens clear with a diamond face, according to an exemplary embodiment of the present disclosure.

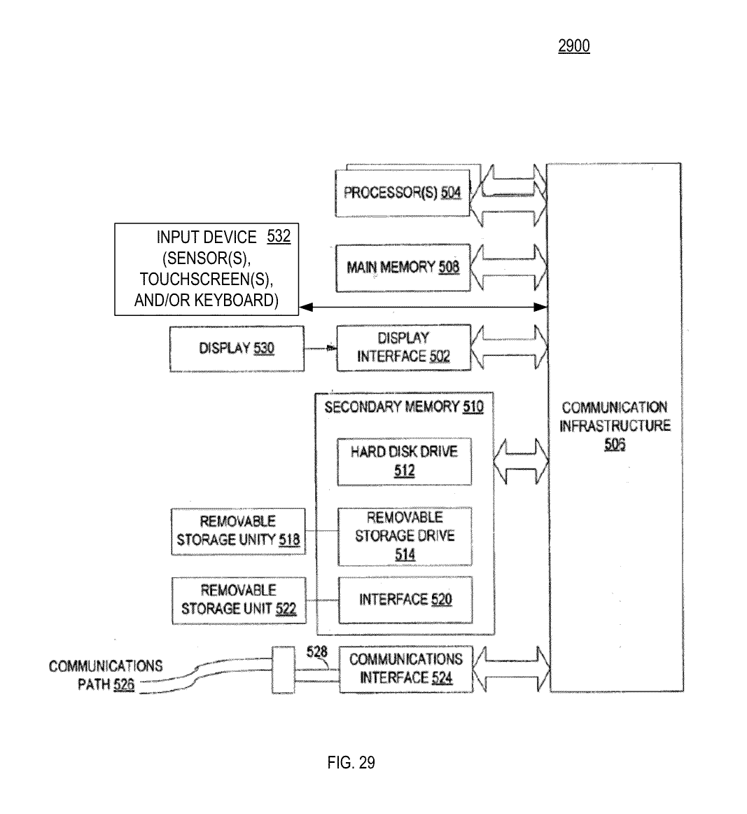

FIG. 29 is an exemplary computer hardware architecture diagram 2900 according to an exemplary embodiment of the present disclosure. depicts an exemplary diagram 2900 illustrating an exemplary computer/communications device hardware architecture as may be used in various components of exemplary embodiments of the present disclosure. FIG. 29 depicts an exemplary view 2900 of an exemplary computer system 102, 104, 112 as may be used in implementing an exemplary embodiment of the present disclosure. FIG. 29 depicts an exemplary embodiment of a computer system that may be used in computing devices such as, e.g., but not limited to, capture device 102, aggregation device 104, and/or server/consolidator device 112 according to an exemplary embodiment of the present disclosure. FIG. 29 depicts an exemplary embodiment of a computer system that may be used as client device 108, or a server device (not shown), etc. The present disclosure (or any part(s) or function(s) thereof) may be implemented using hardware, software, firmware, or a combination thereof and may be implemented in one or more computer systems or other processing systems. In fact, in one exemplary embodiment, the disclosure may be directed toward one or more computer systems capable of carrying out the functionality described herein. An example of a computer system 500 is shown in FIG. 5, depicting an exemplary embodiment of a block diagram of an exemplary computer system useful for implementing the present disclosure. Specifically, FIG. 29 illustrates an example computer 500, which in an exemplary embodiment may be, e.g., (but not limited to) a personal computer (PC) system running an operating system such as, e.g., (but not limited to) WINDOWS MOBILE™ for POCKET PC, or MICROSOFT® WINDOWS® NT/98/2000/XP/CE/, etc. available from MICROSOFT® Corporation of Redmond, Wash., U.S.A., SOLARIS® from SUN® Microsystems of Santa Clara, Calif., U.S.A, OS/2 from IBM® Corporation of Armonk, N.Y, U.S.A, Mac/OS from APPLE® Corporation of Cupertino, Calif., U.S.A, etc, or any of various versions of UNIX® (a trademark of the Open Group of San Francisco, Calif., USA) including, e.g., LINUX®, HPUX®, IBM AIX®, and SCO/UNIX®, etc. However, the disclosure may not be limited to these platforms. Instead, the disclosure may be implemented on any appropriate computer system running any appropriate operating system. In one exemplary embodiment, the present disclosure may be implemented on a computer system operating as discussed herein. An exemplary computer system, computer 500 is shown in FIG. 5. Other components of the disclosure, such as, e.g., (but not limited to) a computing device, a communications device, a telephone, a personal digital assistant (PDA), a personal computer (PC), a handheld PC, client workstations, thin clients, thick clients, proxy servers, network communication servers, remote access devices, client computers, server computers, routers, web servers, data, media, audio, video, telephony or streaming technology servers, a tablet, a phone, a mobile phone, a cellular phone, a communications device, an iPhone, a smartphone, an iPad, a tablet based device, an ANDROID OS device, an iOS device, a Symbian based device, a Windows 8 device, etc., may also be implemented using a computer such as that shown in FIG. 29.

The computer system 2900 may include one or more processors, such as, e.g., but not limited to, processor(s) 504. The processor(s) 504 may be connected to a communication infrastructure 506 (e.g., but not limited to, a communications bus, cross-over bar, or network, etc.). Various exemplary software embodiments may be described in terms of this exemplary computer system. After reading this description, it will become apparent to a person skilled in the relevant art(s) how to implement the disclosure using other computer systems and/or architectures.

Computer system 2900 may include a display interface 502 that may forward, e.g., but not limited to, graphics, text, and other data, etc., from the communication infrastructure 506 (or from a frame buffer, etc., not shown) for display on the display unit 530. An exemplary embodiment of the system can include any of various output devices (such as, e.g., but not limited to, display 530), as well as any of various input devices 532 (such as, e.g., but not limited to, a keyboard, a touchscreen, a sensor, an accelerometer, a multidimensional sensor, a location sensor, a GPS, etc.).

The computer system 2900 may also include, e.g., but may not be limited to, a main memory 508, random access memory (RAM), and a secondary memory 510, etc. The secondary memory 510 may include, for example, (but not limited to) a hard disk drive 512 and/or a removable storage drive 514, representing a floppy diskette drive, a magnetic tape drive, an optical disk drive, a compact disk drive CD-ROM, etc. The removable storage drive 514 may, e.g., but not limited to, read from and/or write to a removable storage unit 518 in a well known manner. Removable storage unit 518, also called a program storage device or a computer program product, may represent, e.g., but not limited to, a floppy disk, magnetic tape, optical disk, compact disk, etc. which may be read from and written to by removable storage drive 514. As will be appreciated, the removable storage unit 518 may include a computer usable storage medium having stored therein computer software and/or data.

In alternative exemplary embodiments, secondary memory 510 may include other similar devices for allowing computer programs or other instructions to be loaded into computer system 2900. Such devices may include, for example, a removable storage unit 522 and an interface 520. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units 522 and interfaces 520, which may allow software and data to be transferred from the removable storage unit 522 to computer system 2900.

Computer 2900 may also include an input device such as, e.g., (but not limited to) a mouse or other pointing device such as a digitizer, and a keyboard or other data entry device (none of which are labeled).

Computer 2900 may also include output devices, such as, e.g., (but not limited to) display 530, and display interface 502. Computer 2900 may include input/output (I/O) devices such as, e.g., (but not limited to) communications interface 524, cable 528 and communications path 526, etc. These devices may include, e.g., but not limited to, a network interface card, and modems (neither are labeled). Communications interface 524 may allow software and data to be transferred between computer system 500 and external devices. Examples of communications interface 524 may include, e.g., but may not be limited to, a modem, a network interface (such as, e.g., an Ethernet card), a communications port, a Personal Computer Memory Card International Association (PCMCIA) slot and card, etc. Software and data transferred via communications interface 524 may be in the form of signals 528 which may be electronic, electromagnetic, optical or other signals capable of being received by communications interface 524. These signals 528 may be provided to communications interface 524 via, e.g., but not limited to, a communications path 526 (e.g., but not limited to, a channel). This channel 526 may carry signals 528, which may include, e.g., but not limited to, propagated signals, and may be implemented using, e.g., but not limited to, wire or cable, fiber optics, a telephone line, a cellular link, an radio frequency (RF) link and other communications channels, etc.

In this document, the terms “computer program medium” and “computer readable medium” may be used to generally refer to media such as, e.g., but not limited to removable storage drive 514, a hard disk installed in hard disk drive 512, and signals 528, etc. These computer program products may provide software to computer system 500. The disclosure may be directed to such computer program products.

References to “one embodiment,” “an embodiment,” “example embodiment,” “various embodiments,” etc., may indicate that the embodiment(s) of the disclosure so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct or indirect physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present disclosure may include apparatuses for performing the operations herein. An apparatus may be specially constructed for the desired purposes, or it may comprise a general purpose device selectively activated or reconfigured by a program stored in the device.

Embodiments of the disclosure may be implemented in one or a combination of hardware, firmware, and software. Embodiments of the disclosure may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

Computer programs (also called computer control logic), may include object oriented computer programs, and may be stored in main memory 508 and/or the secondary memory 510 and/or removable storage units 514, also called computer program products. Such computer programs, when executed, may enable the computer system 500 to perform the features of the present disclosure as discussed herein. In particular, the computer programs, when executed, may enable the processor 504 to provide a method to resolve conflicts during data synchronization according to an exemplary embodiment of the present disclosure. Accordingly, such computer programs may represent controllers of the computer system 2900.

In another exemplary embodiment, the disclosure may be directed to a computer program product comprising a computer readable medium having control logic (computer software) stored therein. The control logic, when executed by the processor 504, may cause the processor 504 to perform the functions of the disclosure as described herein. In another exemplary embodiment where the disclosure may be implemented using software, the software may be stored in a computer program product and loaded into computer system 500 using, e.g., but not limited to, removable storage drive 514, hard drive 512 or communications interface 524, etc. The control logic (software), when executed by the processor 504, may cause the processor 504 to perform the functions of the disclosure as described herein. The computer software may run as a standalone software application program running atop an operating system, or may be integrated into the operating system.

In yet another embodiment, the disclosure may be implemented primarily in hardware using, for example, but not limited to, hardware components such as application specific integrated circuits (ASICs), or one or more state machines, etc. Implementation of the hardware state machine so as to perform the functions described herein will be apparent to persons skilled in the relevant art(s).

In another exemplary embodiment, the disclosure may be implemented primarily in firmware.

In yet another exemplary embodiment, the disclosure may be implemented using a combination of any of, e.g., but not limited to, hardware, firmware, and software, etc.

Exemplary embodiments of the disclosure may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

The exemplary embodiment of the present disclosure makes reference to wired, or wireless networks. Wired networks include any of a wide variety of well known means for coupling voice and data communications devices together. A brief discussion of various exemplary wireless network technologies that may be used to implement the embodiments of the present disclosure now are discussed. The examples are non-limited. Exemplary wireless network types may include, e.g., but not limited to, code division multiple access (CDMA), spread spectrum wireless, orthogonal frequency division multiplexing (OFDM), 1G, 2G, 3G wireless, Bluetooth, Infrared Data Association (IrDA), shared wireless access protocol (SWAP), “wireless fidelity” (Wi-Fi), WIMAX, and other IEEE standard 802.11 compliant wireless local area network (LAN), 802.16-compliant wide area network (WAN), Zigbee wireless, 802.15-compliant wireless network, and/or ultrawideband (UWB), etc.

Bluetooth is an emerging wireless technology promising to unify several wireless technologies for use in low power radio frequency (RF) networks.

IrDA is a standard method for devices to communicate using infrared light pulses, as promulgated by the Infrared Data Association from which the standard gets its name. Since IrDA devices use infrared light, they may depend on being in line of sight with each other.

The exemplary embodiments of the present disclosure may make reference to WLANs. Examples of a WLAN may include a shared wireless access protocol (SWAP) developed by Home radio frequency (HomeRF), and wireless fidelity (Wi-Fi), a derivative of IEEE 802.11, advocated by the wireless ethernet compatibility alliance (WECA). The IEEE 802.11 wireless LAN standard refers to various technologies that adhere to one or more of various wireless LAN standards. An IEEE 802.11 compliant wireless LAN may comply with any of one or more of the various IEEE 802.11 wireless LAN standards including, e.g., but not limited to, wireless LANs compliant with IEEE std. 802.11a, b, d or g, such as, e.g., but not limited to, IEEE std. 802.11a, b, d and g, (including, e.g., but not limited to IEEE 802.11g-2003, etc.), etc. In an exemplary embodiment, an exemplary Zigbee wireless transceiver may be used, which may be used to address a wide range of exemplary IEEE 802.15.4-compliant devices and network elements.

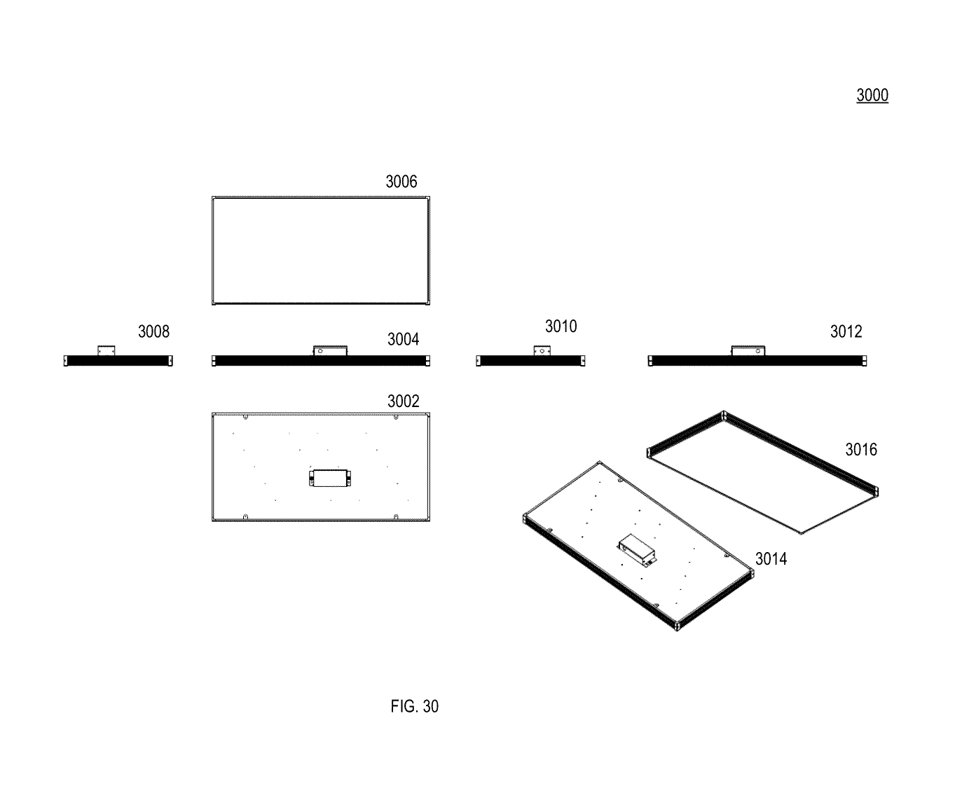

FIG. 30 is an exemplary top, front, bottom, right and left side orthogonal front view, as well as an isometric bottom and top view of an exemplary rectangular LED troffer light, according to an exemplary embodiment.

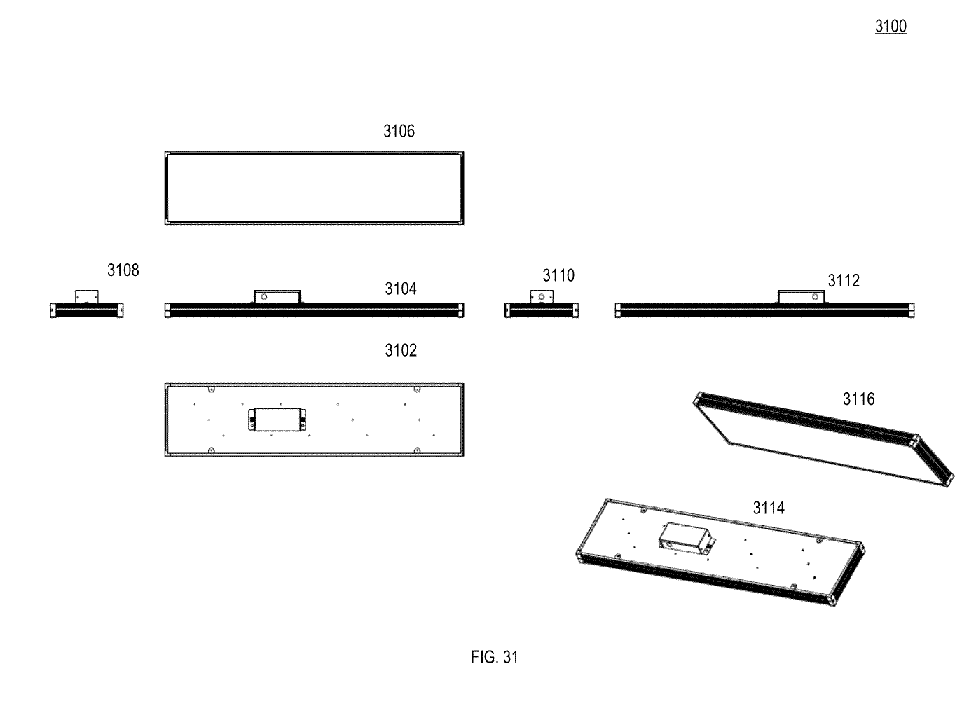

FIG. 31 is another exemplary top, front, bottom, right and left side orthogonal front view, as well as an isometric bottom and top view of an exemplary narrow rectangular LED troffer light, according to an exemplary embodiment.

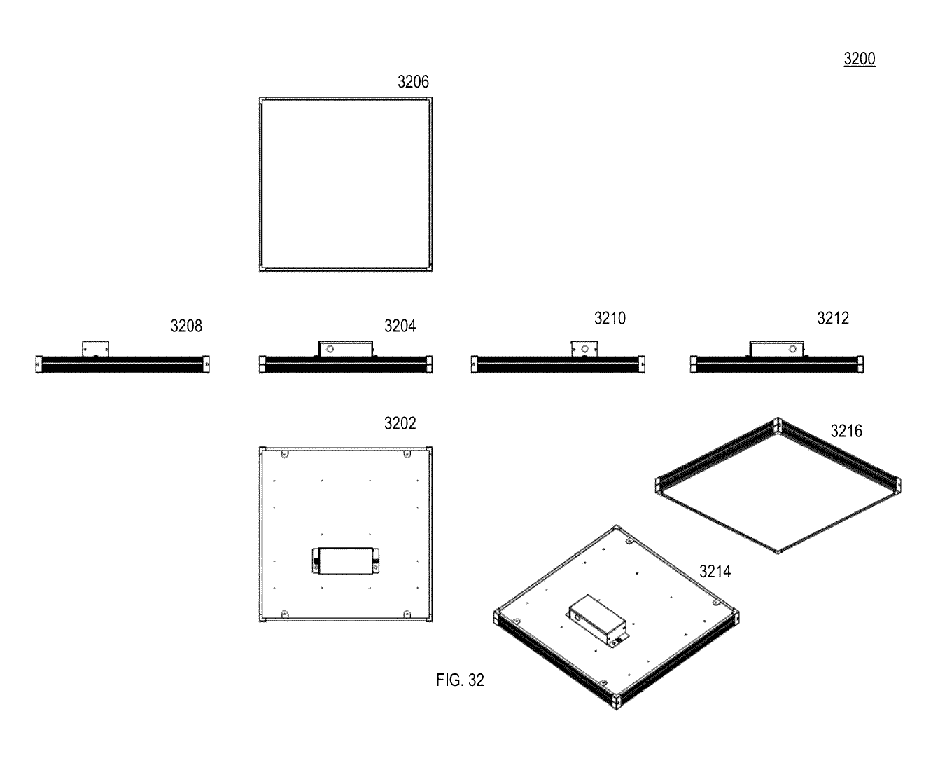

FIG. 32 is an exemplary top, front, bottom, right and left side orthogonal front view, as well as an isometric bottom and top view of an exemplary square LED troffer light, according to an exemplary embodiment.

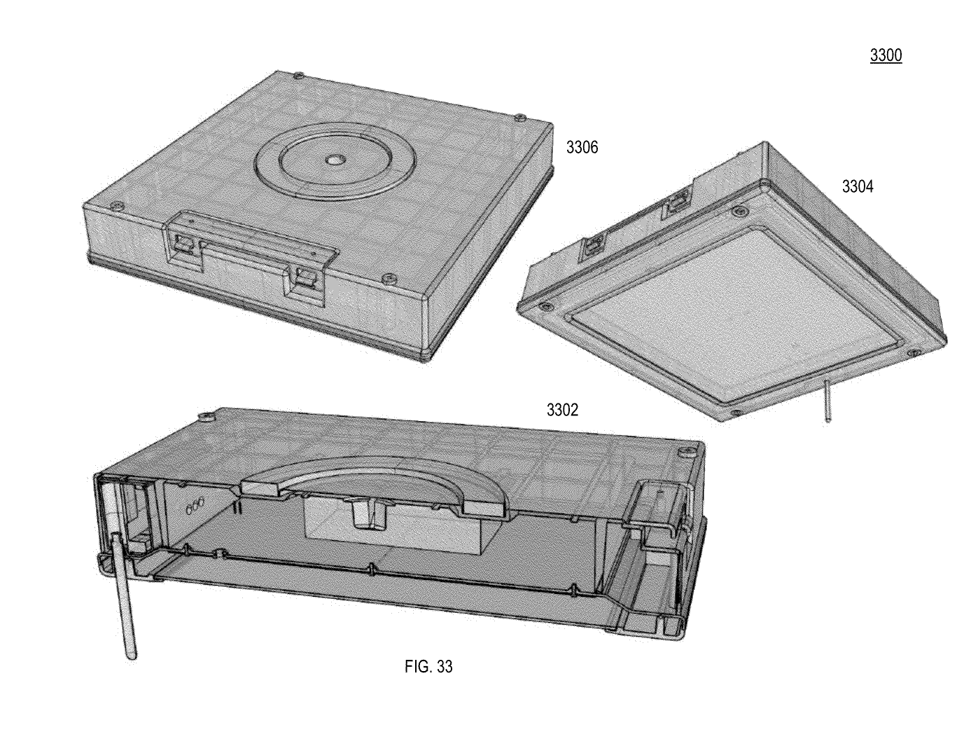

FIG. 33 is an exemplary top, and bottom view, and cutaway cross-section of a canopy zigbee system for an exemplary square troffer, according to an exemplary embodiment.

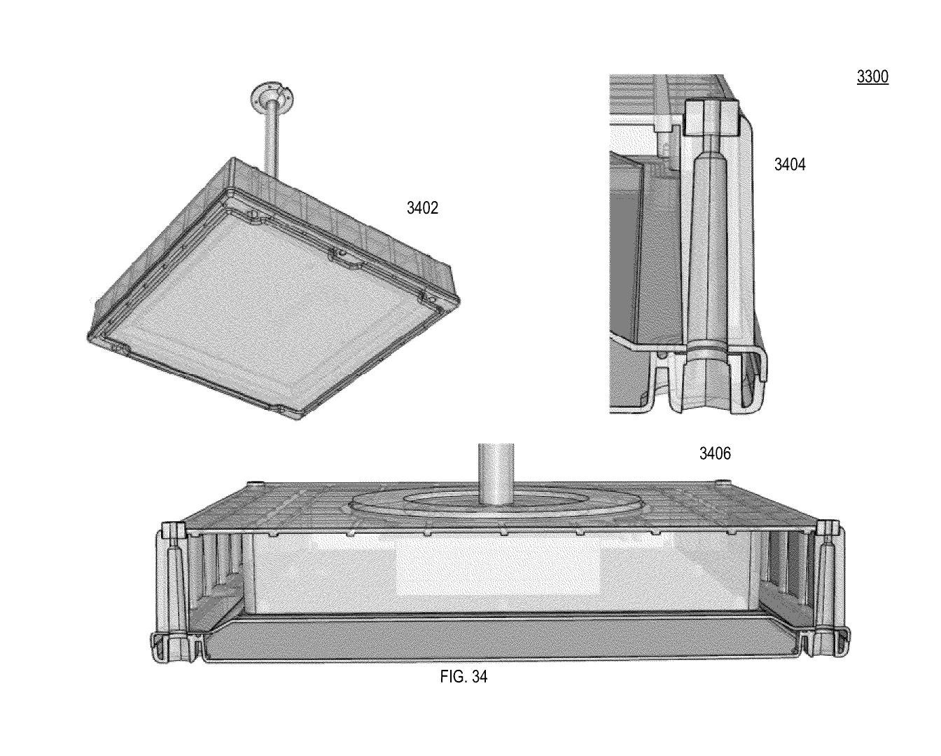

FIG. 34 is an exemplary bottom view, and cutaway cross-sections of a canopy zigbee system for an exemplary square troffer, according to an exemplary embodiment.

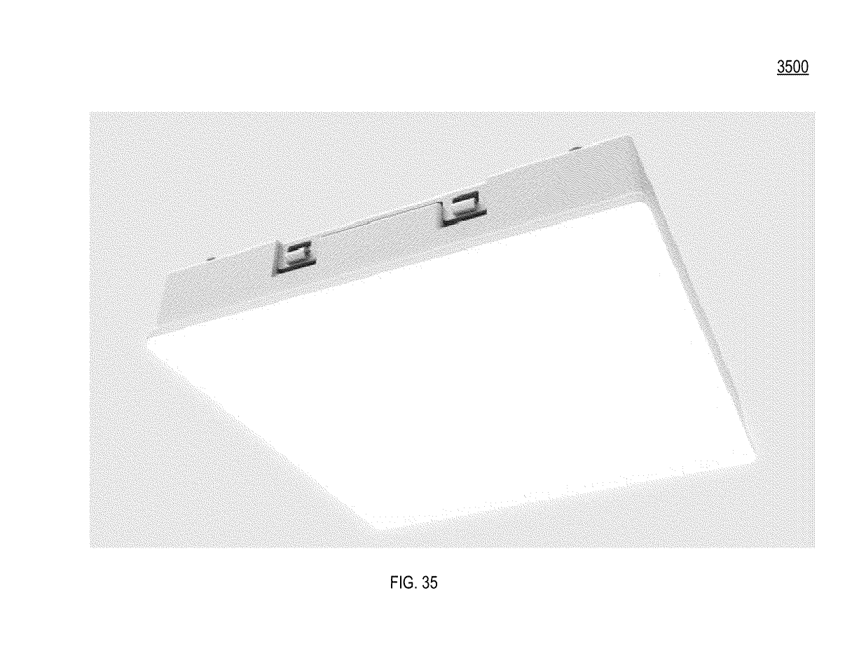

FIG. 35 is an exemplary underside view of an exemplary square troffer, according to an exemplary embodiment.

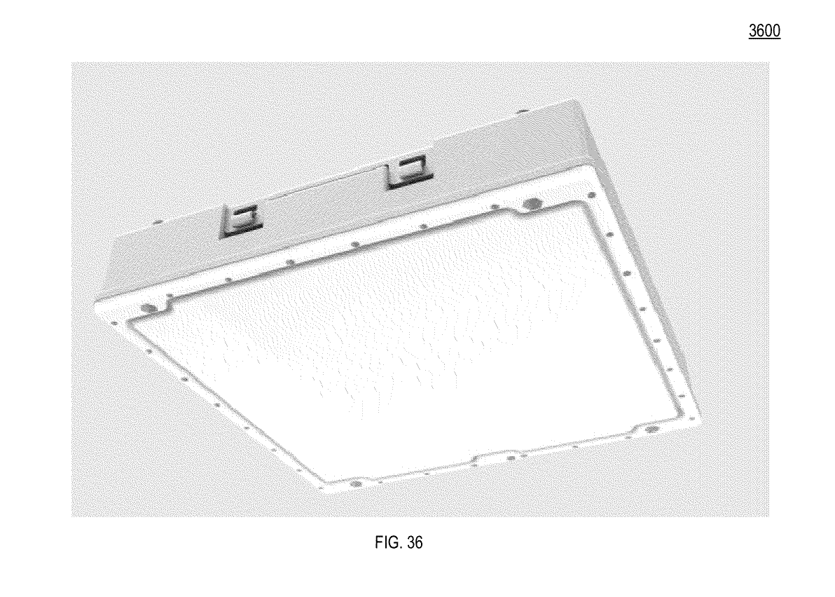

FIG. 36 is an exemplary bottom view of an exemplary square troffer, according to an exemplary embodiment.

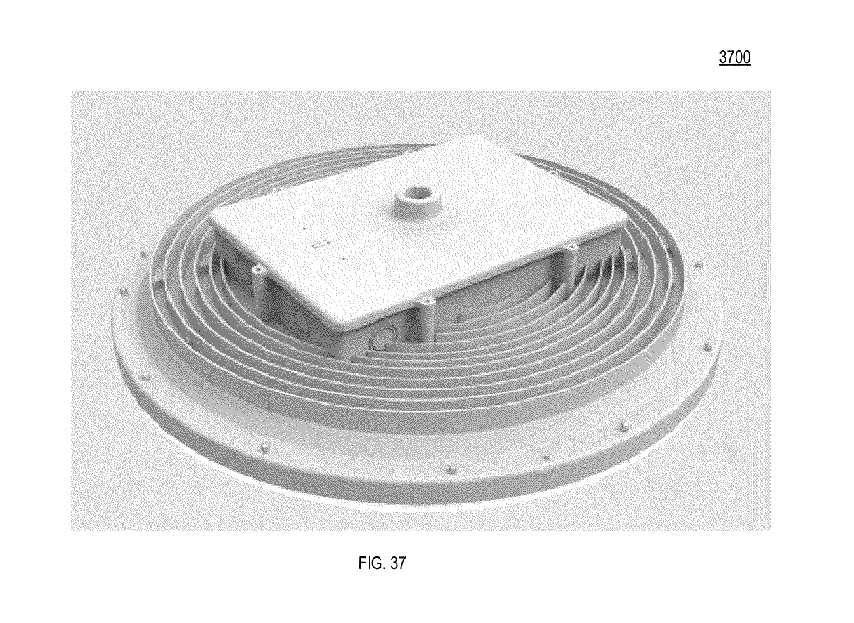

FIG. 37 is an exemplary top view of an exemplary highbay, according to an exemplary embodiment.

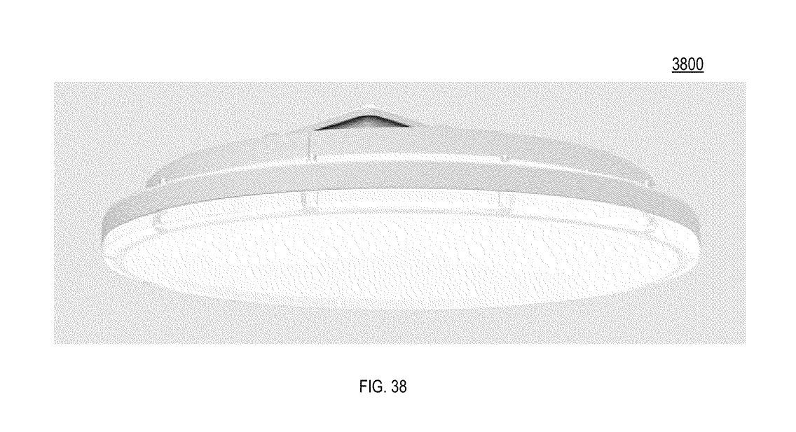

FIG. 38 is an exemplary underside view of an exemplary highbay when illuminated, according to an exemplary embodiment.

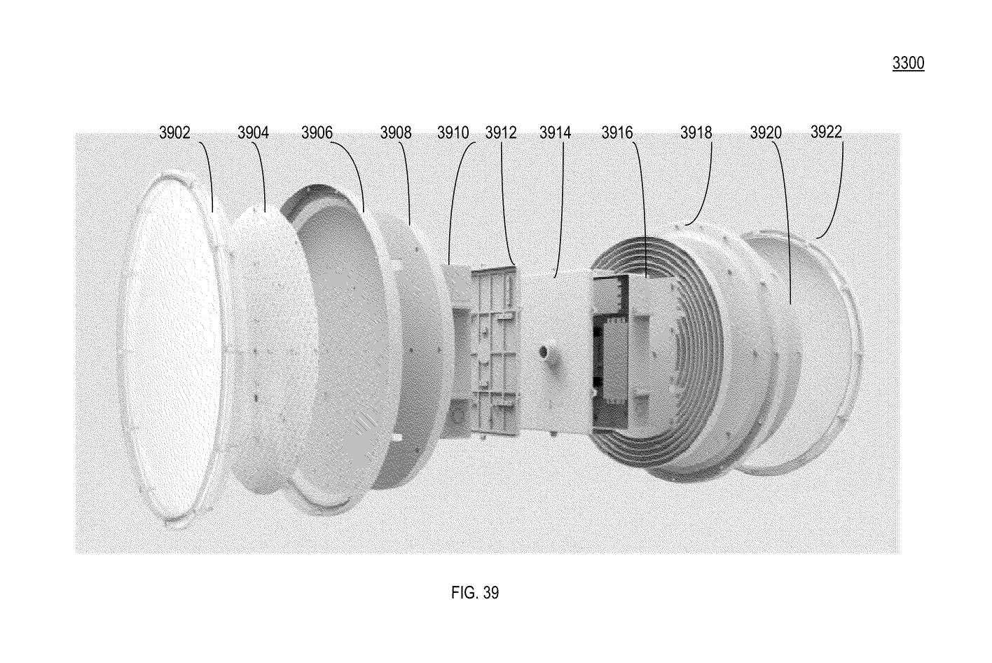

FIG. 39 is an exemplary exploded view of an exemplary highbay, according to an exemplary embodiment.

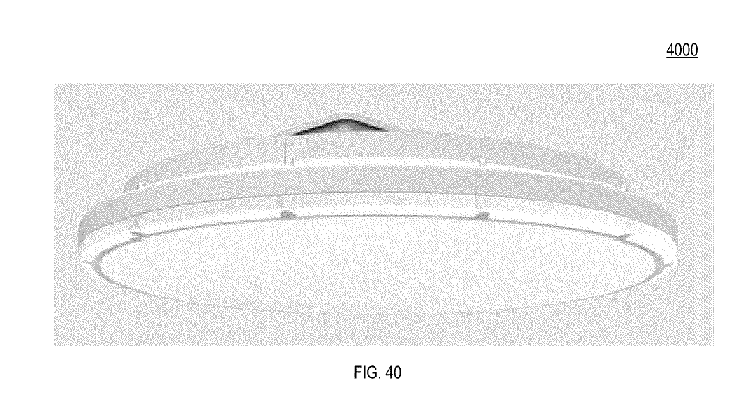

FIG. 40 is an exemplary underside view of an exemplary highbay, according to an exemplary embodiment.

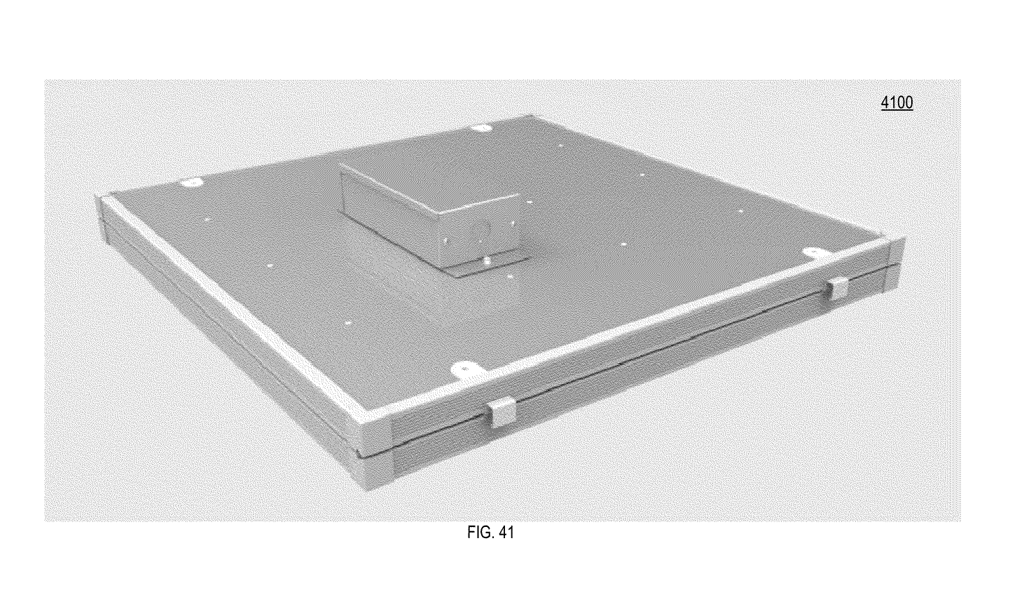

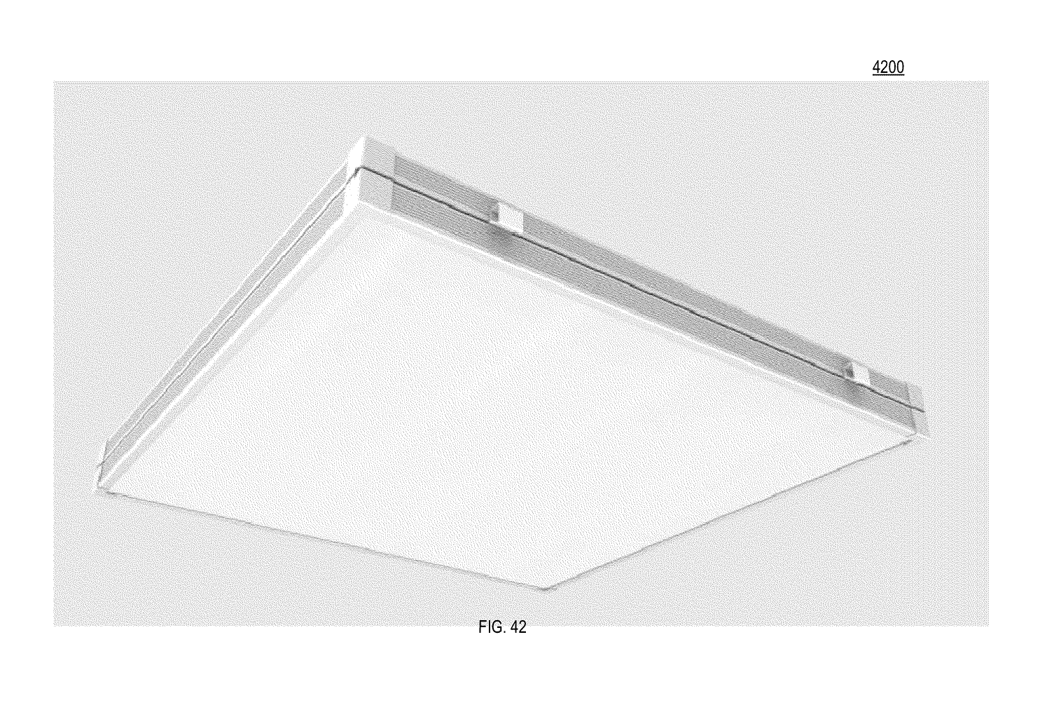

FIG. 41 is an exemplary top view of an exemplary square troffer, according to an exemplary embodiment.

FIG. 42 is an exemplary underside view of an exemplary square troffer, according to an exemplary embodiment.

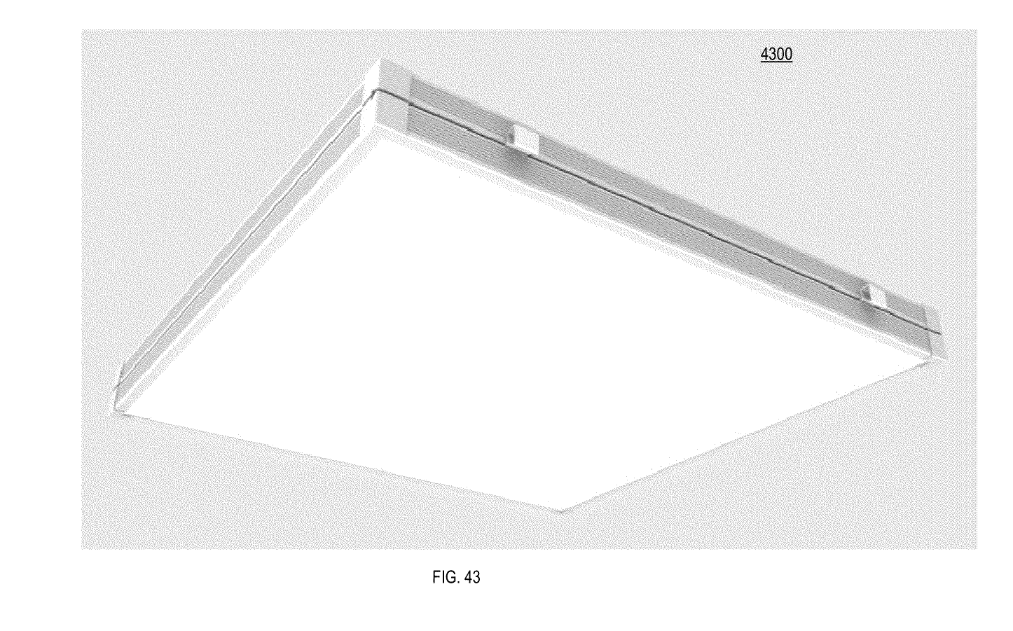

FIG. 43 is an exemplary underside view of an exemplary square troffer when illuminated, according to an exemplary embodiment.

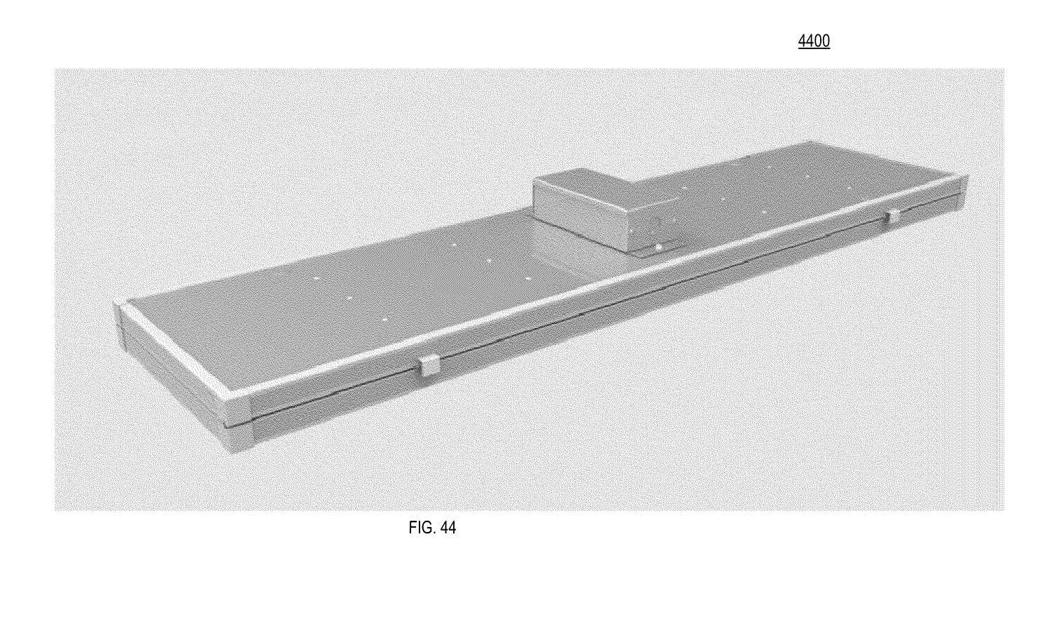

FIG. 44 is an exemplary top view of an exemplary narrow rectangular troffer, according to an exemplary embodiment.

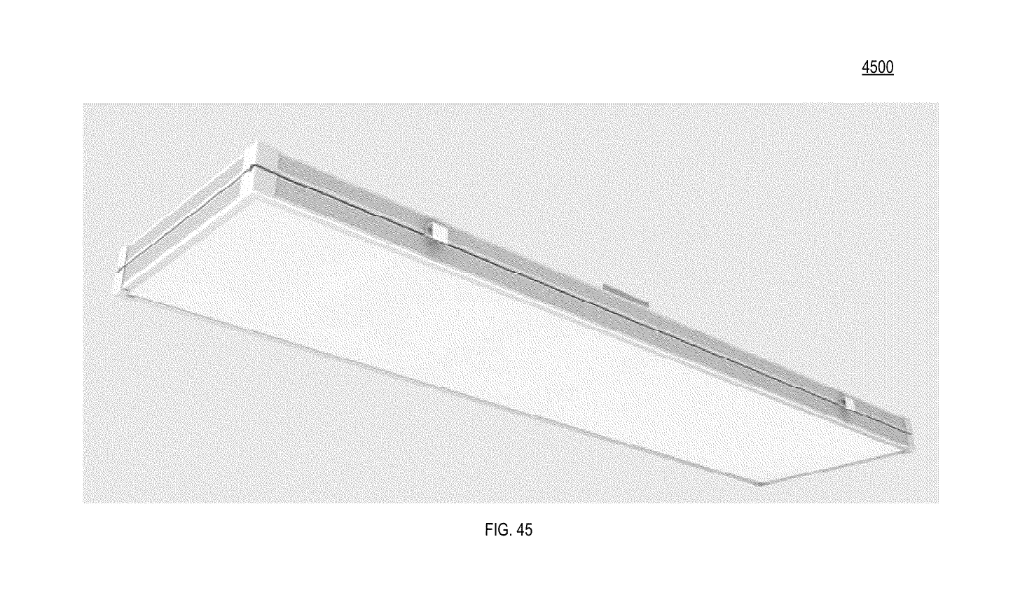

FIG. 45 is an exemplary underside view of an exemplary narrow rectangular troffer, according to an exemplary embodiment.

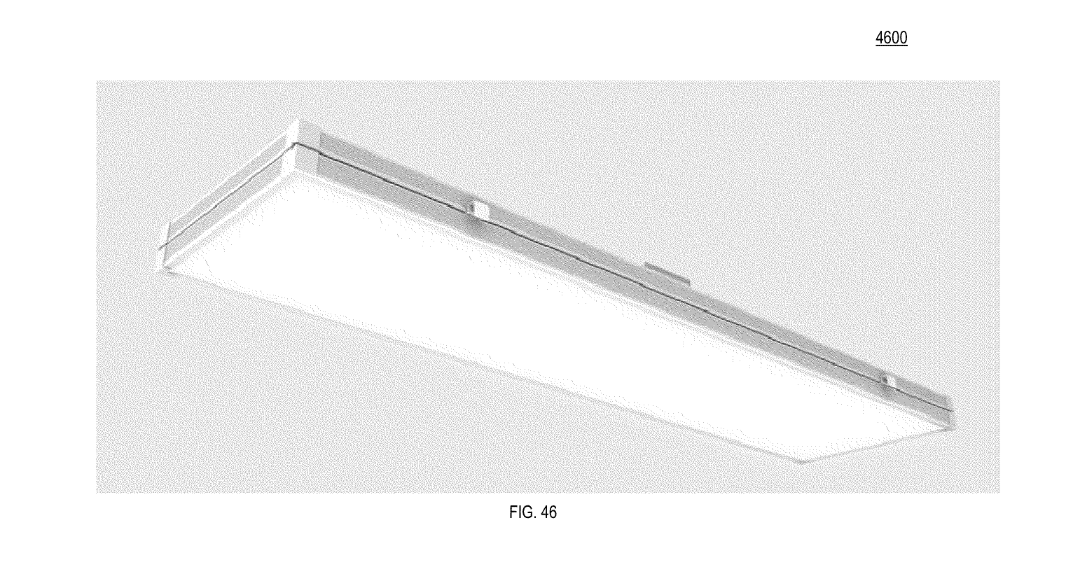

FIG. 46 is an exemplary underside view of an exemplary narrow rectangular troffer when illuminated, according to an exemplary embodiment.

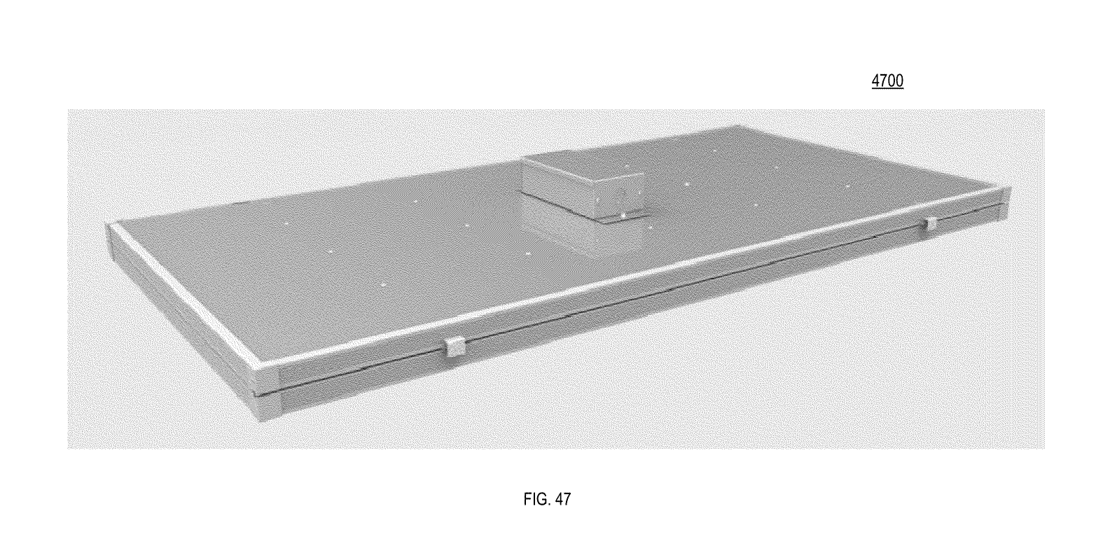

FIG. 47 is an exemplary top view of an exemplary rectangular troffer, according to an exemplary embodiment.

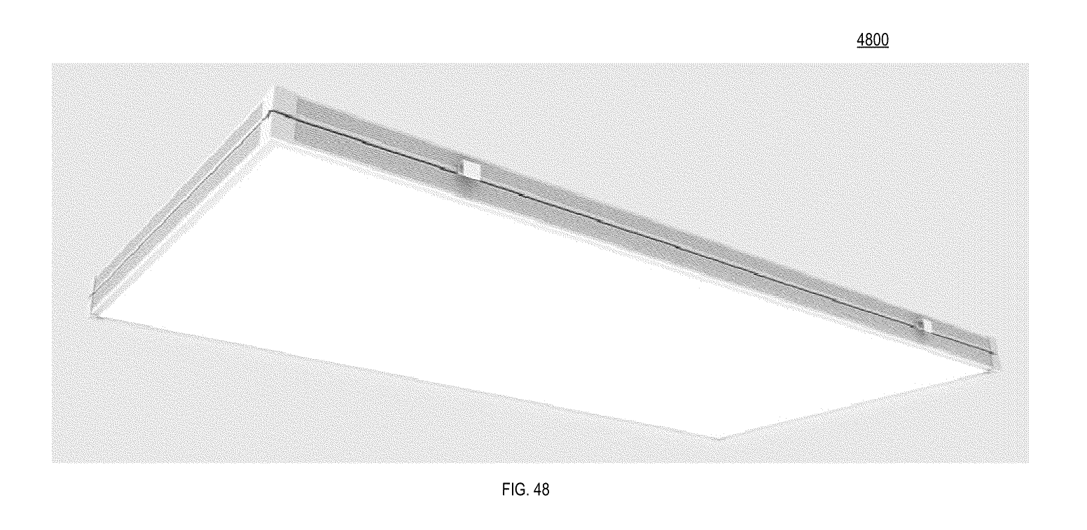

FIG. 48 is an exemplary underside view of an exemplary rectangular troffer when illuminated, according to an exemplary embodiment.

According to one exemplary embodiment of the disclosure, embodiments aim to save electricity and reduce carbon emissions.

Exemplary embodiments may include a physical structure—as depicted in exemplary FIGS. 30-48.

According to exemplary embodiments, exemplary features, operations, functions, and uses may include, among others, an exemplary high Lumen light emitting diode (LED) chips, an exemplary High PF driver to make the exemplary troffer produce more than 100 lm/W.

According to an exemplary embodiment, various exemplary features and alternative embodiment can include 1) Compared to conventional panel lights, an exemplary embodiment of the troffer can produce lighting lumens of about 100 lm/W, which is much higher than conventional LED lights (exemplary conventional market panel lights produce about 80-90 lm/w); 2) according to an exemplary embodiment, an exemplary PC diffusion cover, and an exemplary ABS frame, can be provided, contributing to the whole fixture being lighter in weight in an exemplary embodiment; and/or 3) an exemplary backside AL plate cooling is better than conventional SPCC (Metal case), in an exemplary embodiment.

Exemplary Parts listings for an exemplary driver circuit may include for an exemplary 50 W; KR001(5000 lm):

| 0805 | 4.7 nF/50 v | C3 | 1 |
|---|---|---|---|
| 0805 | 1 nF/50 v | C5 C11 | 2 |
| 1206 | 22 uF/16 V | C6 | 1 |
| 0805 | 0.22 uF/50 v | C7 | 1 |
| 0805 | 0.1 uF/50 V | C8 C22 C28 | 3 |
| 1206 | 4.7 uF/50 V | C9 C21 | 2 |
| 0805 | 10 nF/50 V | C10 C12 C19 C27 | 4 |
| 1206 | 102/1 KV | C13 | 1 |
| 1206 | 1 uF/50 V | C17 | 1 |
| 1206 | 222/1 KV | C18 | 1 |
| 0805 | 18 nF50 V | C20 | 1 |
| 1206 | 2.2 uF/10 V | C23 | 1 |
| 1206 | 221/1 KV | CA | 1 |
| 1206 | 101/1 KV | CB | 1 |
| 1206 | 1M 1/2 W | R1 R2 R29 R30 | 4 |
| 1206 | 1.5M | R3 R4 R10 R11 | 4 |
| 0805 | 20K | R5 | 1 |
| 1206 | 33k | R6 | 1 |
| 1206 | 68R | R7 R16 | 2 |
| 0805 | 10K | R8 R17 R26 R40 | 4 |
| 0805 | 30K 1% | R12 | 1 |
| 0805 | 510R | R13 R15 | 2 |
| 0805 | 300R | R14 | 1 |
| 1206 | 150K | R18 R19 R27 | 3 |
| 1206 | 3.9K 1% | R20 | 1 |
| 1206 | 1K | R21 R36 | 2 |
| 0805 | 0R | R22 | 1 |
| 1206 | 1R | R25 | 1 |
| 1206 | 30K | R28 | 1 |
| 1206 | 2.2R | R31 | 1 |
| 1206 | 0R | R32 | 1 |
| 0805 | 4.7K | R33 | 1 |
| 0805 | 47R | R34 R35 | 2 |
| 0805 | 51K 1% | R38 | 1 |
| 805 | 3.9K 1% | R39 | 1 |
| 1206 | OR | R41 | 1 |
| 0805 | 100K | R42 | 1 |
| 0805 | 39K 1% | R43 | 1 |
| 0805 | 22K | R44 | 1 |
| 0805 | 15K | R45 | 1 |
| 0805 | 2.2K | R46 | 1 |
| 1206 | 10K | R47 R48 | 2 |
| 1206 | 15K | R49 | 1 |
| 1206 | 100R | R50 R53 R54 | 3 |
| 1206 | 10K | R51 | 1 |
| 1206 | 10mR/1 W alloy | R52 | 1 |
| SOT23WS | MMBT3904 | Q4 Q5 | 2 |
| SOT23WS | MMBT2222A/1P | Q6 Q8 | 2 |
| SOT23WS | MMBT2907A/2F | Q7 | 1 |
| SOP-8 | OB6563 | U1 | 1 |
| SOP-8 | TEA1761T | U3 | 1 |
| SOP-8 | OB2203CP | U4 | 1 |
| SOP-8 | XL1509-5.0 | U5 | 1 |
| GBU-4P | GBU4J/GBU406/ | BD1 | 1 |
| | GBU410 | | |
| 18 * 14.5 * 8.4 * 15 | MPR-310 V-X2-334K | CX1 | 1 |
| P = 10 mm | 400VAC222M | CY1 CY2 CY3 CY4 | 4 |
| P = 10 mm | MEX-474J450V | C1 C2 | 2 |
| φ18 * 25 | 450 V68 uF | C4 | 1 |
| φ5 * 11 | 50 V22 uF | C14 C25 | 2 |
| φ10 * 16 | 35 V470 uF | C15 C16 C24 | 3 |
| φ6.3 * 12 | 10 V470 uF | C26 | 1 |
| 2 W | 0.47R | R9 | 1 |
| 2 W | 0.33R | R23 | 1 |
| 1/8W | 47K 1% | R24 | 1 |
| φ0.8 * 7 mm | 39mR | R37 | 1 |
| DO-201AD | MUR460 | D1 | 1 |
| SOD-123 | 1N4148W | D2 D4 D6 | 3 |
| DO41 | FR207 | D3 | 1 |
| DO41 | FR107 | D5 | 1 |
| DO214AC | SS14 | D7 | 1 |
| T392/φ3.6 × 10 | T3.15A 250 V | F1 | 1 |
| T12.7 * 7.9 * 4.5 C. | 4 mH (0.5 mm | L1 | 1 |
| | WIRED AND | | |
| | AROUND) | | |
| T16 * 9 * 7 C. | 22 mH (0.5 mm | L2 | 1 |
| | DOUBLE TO | | |
| | AROUND) | | |
| T60-52 | 470-580 uH (0.5 mm | L3 | 1 |
| | SINGLE WOUND) | | |
| RM-10 | 1000 uH | L4 | 1 |
| φ3.6 * 8 | 1-3.3 uH 0.6 mm line | L5 | 1 |
| φ8 * 10 | 68-100 uH (0.3 mm | L6 | 1 |
| | single wound) | | |
| T0-220 F. | IPA65R600C6 | Q1 Q2 | 2 |
| T0-220 | NCE1579C | Q3 | 1 |
| T0-220 | NCE55H12 | Q9 | 1 |
| P = 10 mm | NTC5D-9 | RT1 | 1 |
| P = 3.5 mm | 104/100K | RT2 | 1 |
| P = 7.5 mm | 10D471K | RV1 | 1 |
| PQ2620 | 950 uH/32 V | T1 | 1 |
| DIP-4P | EL817C | U2 | 1 |
| 3P * 1.25 mm DIP | | J2 | 1 |
| 6P * 1.25 mm DIP | | J3 | 1 |
| 20 AWG | | L N G | 1 |
| 20 AWG | | LED+ LED− | 1 |
| 20 AWG YELLOW GREEN WIRE | | FG | 1 |
| 84 * 20 * 2 mm straight type | | J1 | 1 |
| 65 * 20 * 2 mm 7 font | | J4 | 1 |
| 65 * 20 * 2 mm 7 font | | J5 | 1 |
| 3.5 * 3 * 1.5 mm | Y capacitance secondary | CY1 Q1 Q2 | 3 |
| | foot, Q1, Q2-2foot | | |
| 3.5 * 6 * 1.0 mm | | D3 | 1 |
| 3.5 * 9 * 1.5 mm | | D1 | 1 |
| FR4/1 ounce | 160 * 56 * 1.6 mm | KR001 | 1 |

Exemplary Parts listings for an exemplary driver circuit may include for an exemplary 80-100 W W, KR002(8000 lm):

| 0805 | 4.7 nF/50 v | C3 | 1 |
|---|---|---|---|
| 0805 | 1 nF/50 v | C5 C11 | 2 |
| 1206 | 22 uF/16 V | C6 | 1 |
| 0805 | 0.22 uF/50 v | C7 | 1 |
| 0805 | 0.1 uF/50 V | C8 C22 C28 | 3 |
| 1206 | 4.7 uF/50 V | C9 C21 | 2 |
| 0805 | 10 nF/50 V | C10 C12 C19 C27 | 4 |
| 1206 | 102/1 KV | C13 | 1 |
| 1206 | 1 uF/50 V | C17 | 1 |
| 1206 | 222/1 KV | C18 | 1 |
| 0805 | 18 nF50 V | C20 | 1 |
| 1206 | 2.2 uF/10 V | C23 | 1 |
| 1206 | 221/1 KV | CA | 1 |
| 1206 | 101/1 KV | CB | 1 |
| 1206 | 1M 1/2 W | R1 R2 R29 R30 | 4 |
| 1206 | 1.5M | R3 R4 R10 R11 | 4 |
| 0805 | 20K | R5 | 1 |
| 1206 | 33k | R6 | 1 |
| 1206 | 68R | R7 R16 | 2 |
| 0805 | 10K | R8 R17 R26 R40 | 4 |
| 0805 | 30K 1% | R12 | 1 |
| 0805 | 510R | R13 R15 | 2 |
| 0805 | 300R | R14 | 1 |
| 1206 | 150K | R18 R19 R27 | 3 |
| 1206 | 3.9K 1% | R20 | 1 |
| 1206 | 1K | R21 R36 | 2 |
| 0805 | 0R | R22 | 1 |
| 1206 | 1R | R25 | 1 |
| 1206 | 30K | R28 | 1 |
| 1206 | 2.2R | R31 | 1 |
| 1206 | 0R | R32 | 1 |
| 0805 | 4.7K | R33 | 1 |
| 0805 | 47R | R34 R35 | 2 |
| 0805 | 51K 1% | R38 | 1 |
| 0805 | 3.9K 1% | R39 | 1 |
| 1206 | 0R | R41 | 1 |
| 0805 | 100K | R42 | 1 |
| 0805 | 39K 1% | R43 | 1 |
| 0805 | 22K | R44 | 1 |
| 0805 | 15K | R45 | 1 |
| 0805 | 2.2K | R46 | 1 |
| 1206 | 10K | R47 R48 | 2 |
| 1206 | 15K | R49 | 1 |
| 1206 | 100R | R50 R53 R54 | 3 |
| 1206 | 10K | R51 | 1 |
| 1206 | 10 mR/1 W alloy | R52 | 1 |
| SOT23WS | MMBT3904 | Q4 Q5 | 2 |
| SOT23WS | MMBT2222A/1P | Q6 Q8 | 2 |
| SOT23WS | MMBT2907A/2F | Q7 | 1 |
| SOP-8 | OB6563 | U1 | 1 |
| SOP-8 | TEA1761T | U3 | 1 |
| SOP-8 | OB2203CP | U4 | 1 |
| SOP-8 | XL1509-5.0 | U5 | 1 |
| GBU-4P | GBU4J/GBU406/ | BD1 | 1 |
| | GBU410 | | |
| 18 * 15.8 * 10 * 15/18 * | MPR-310 V-X2- | CX1 | 1 |
| 14.5 * 8.4 * 15 | 474K | | |
| P = 10 mm | 400VAC222M | CY1 CY2 CY3 CY4 | 4 |
| P = 10 mm | MEX-474J450 V | C1 C2 | 2 |
| φ18 * 36 | 450 V100/120 uF | C4 | 1 |
| φ5 * 11 | 50 V22 uF | C14 C25 | 2 |
| φ10 * 20 | 35V680 | C15 C16 C24 | 3 |
| φ6.3 * 12 | 10 V470 uF | C26 | 1 |
| 2 W | 0.18 | R9 | 1 |
| 2 W | 0.18 | R23 | 1 |
| 1/8 W | 47K 1% | R24 | 1 |
| φ1.0 * 7 mm | 18.5mR-3A/25mR- | R37 | 1 |
| | 2.2A | | |
| DO-201AD | MUR460 | D1 | 1 |
| SOD-123 | 1N4148W | D2 D4 D6 | 3 |
| DO41 | FR207 | D3 | 1 |
| DO41 | FR107 | D5 | 1 |
| DO214AC | SS14 | D7 | 1 |
| T392/φ3.6 × 10 | T3.15A 250 V | F1 | 1 |
| T12.7 * 7.9 * 4.5 C. | 4 mH (0.5 mm wire | L1 | 1 |
| | and around) | | |
| T16 * 9 * 7 C. | 22 mH (0.5 mm | L2 | 1 |
| | double to | | |
| | around) | | |
| T60-52 | 470-580 uH | L3 | 1 |
| | (0.5 mm single | | |
| | wound) | | |
| RM-10 | 580 uH | L4 | 1 |
| φ3.6 * 8 | 1-3.3 uH 0.6 mm | L5 | 1 |
| | line | | |
| φ8 * 10 | 68-100 uH (0.3 mm | L6 | 1 |
| | single wound) | | |
| T0-220 F. | IPA65R380C6 | Q1 Q2 | 2 |
| T0-220 | NCE1579C | Q3 | 1 |
| T0-220 | NCE55H12 | Q9 | 1 |
| P = 10 mm | NTC5D-9 | RT1 | 1 |
| P = 3.5 mm | 104/100K | RT2 | 1 |
| P = 7.5 mm | 10D471K | RV1 | 1 |
| PQ3220/2620 | 430 uH-100 W/ | T1 | 1 |
| | 550 uH-80 W/ | | |
| | 32 V | | |
| DIP-4P | EL817C | U2 | 1 |
| 3P * 1.25 mm (DIP) | | J2 | 1 |
| 6P * 1.25 mm (DIP) | | J3 | 1 |
| 20 AWG | | L N G | 1 |
| 20 AWG | | LED+ LED− | 1 |
| 20 AWG Yellow Green Wire | | FG | 1 |
| 84 * 20 * 2 mm Straight Type | | J1 | 1 |
| 65 * 20 * 2 mm 7font | | J4 | 1 |
| 65 * 20 * 2 mm 7font | | J5 | 1 |
| 3.5 * 3 * 1.5 mm | Y Capacitance | CY1 Q1 Q2 | 3 |
| | secondary | | |
| | foot, Q1, Q2-2foot | | |
| 3.5 * 6 * 1.0 mm | | D3 | 1 |
| 3.5 * 9 * 1.5 mm | | D1 | 1 |
| FR4/1 [symbol] | 160 * 56 * 1.6 mm | KR002 | 1 |

The ALSET™ LED Lighting line, according to an exemplary embodiment stands out for its energy efficiency, making it a highly economical choice—eliminating the cost and labor of frequent lamp replacement over time—while delivering top performance. ALSET™ carries the coveted DLC or Energy Star Rating. The new ALSET™ line includes approximately 20 SKUs, from commercial fixtures, such as canopies, highbays, and troffers to ceiling units, such as downlight retrofits, as illustrated in the exemplary figures and appendices. According to one exemplary embodiment, these commercial fixtures are lightweight for easy installation, according to an exemplary embodiment. According to one exemplary embodiment, the line also can include standard sized residential bulbs, including Flood, Candle, and All-Purpose bulbs, with a proprietary heat management system that yields a longer life than traditional LED light bulbs, in an exemplary embodiment.

### LED Frosted Canopy Fixture

According to one exemplary embodiment, the ALSET™ LED Frosted Canopy Fixture is perfect for indoor and outdoor applications, including warehouses, storage areas and pool deck lighting. Available in 4000 k and 5000 k color temperatures, and IP65 Rated for wet locations, according to an exemplary embodiment. The fixture instantly reaches full brightness, with a wide light distribution and a frosted diffuser to reduce glare, according to an exemplary embodiment. Embodiments can be fully dimmable and offers a high efficacy at 133 lumens per watt, according to an exemplary embodiment. Embodiments can be lightweight for easy installation, according to an exemplary embodiment. Embodiments can be UL and DLC certified, according to an exemplary embodiment.

### 4″ and 6″ Downlight Retrofit

According to one exemplary embodiment, the ALSET™ Downlight Retrofit is perfect for use in homes or offices. Embodiments can feature a frosted lens to reduce glare, and adjustable mounting springs on the 6″ model, allowing it to fit 5″-6″ recessed housings, according to an exemplary embodiment. Embodiments of this luminaire can offer high efficacy, up to 112 lumens per watt, is fully dimmable, and can be available in 2700 k and 3500 k, according to an exemplary embodiment. Embodiments can be UL and Energy Star certified, according to an exemplary embodiment.

### LED Frosted Highbay Fixture

According to one exemplary embodiment, the ALSET™ LED Frosted Highbay Fixture is great for indoor and outdoor applications, including warehouse and storage areas. From the moment the switch is flipped, it instantly reaches full brightness, with a wide light distribution and a frosted diffuser to reduce glare, according to an exemplary embodiment. Embodiments can be fully dimmable and can offer a high efficacy at 119 lumens per watt, according to an exemplary embodiment. Embodiments can be available in 4000 k and 5000 k color temperatures, and can be IP65 Rated for wet locations, according to an exemplary embodiment. Embodiments can be lightweight for easy installation, according to an exemplary embodiment. Embodiments can be UL and DLC certified, according to an exemplary embodiment.

### 2′×2′ Frosted LED Troffer

According to one exemplary embodiment, the ALSET™ 2′×2′ Frosted LED Troffer is energy efficient, eliminating the cost and labor of frequent maintenance over time. Perfect for offices, workshops and indoor area lighting, according to an exemplary embodiment. Embodiments of the fixture can instantly reach full brightness, with a frosted diffuser to reduce glare, according to an exemplary embodiment. Embodiments can be offer a high efficacy at 100 lumens per watt, with 3500 k and 4000 k color temperatures available, according to an exemplary embodiment. Embodiments can be UL and DLC certified, according to an exemplary embodiment. Embodiments can be IP65 Rated for damp locations, according to an exemplary embodiment. Embodiments can be lightweight for easy installation, according to an exemplary embodiment.

### 2′×4′ Troffer Frosted LED Troffer

According to one exemplary embodiment, the ALSET™ 2′×4 Frosted LED Troffer is ideal for offices, workshops and indoor area lighting. From the moment the switch is flipped, the fixture instantly can reach full brightness, with a frosted diffuser to reduce glare. Embodiments can be fully dimmable, and can offer a high efficacy at 100 lumens per watt. Embodiments can be available in 3500 k and 4000 k color temperatures, and can be IP65 Rated for damp locations. Embodiments can be lightweight for easy installation. Embodiments can be UL and DLC certified.

While various embodiments of the present disclosure have been described above, it should be understood that they have been presented by way of example only, and not limitation. Thus, the breadth and scope of the present disclosure should not be limited by any of the above described exemplary embodiments, but should instead be defined only in accordance with the following claims and their equivalents.

What is claimed is:

1. An light emitting diode (LED) system comprising:
an LED lighting source device comprising a plurality of LEDs;
a controller coupled to said LED lighting source device configured to control said plurality of LEDs; and
a wireless transceiver coupled to said controller and configured to wirelessly couple to a remote control device.

2. The LED system according to claim 1, wherein said LED lighting source device comprises at least one of:
a troffer LED lighting source device;
a high bay LED lighting source device; or
a canopy LED lighting source device.

3. The LED system according to claim 1, further comprising at least one of:
an illuminance sensing device;
a light sensor; or
a daylight harvesting sensor.

4. The LED system according to claim 1, further comprising:
The remote control device.

5. The LED system according to claim 4, wherein said remote control device comprises at least one of:
a special purpose remote control device; or
a smartphone configured with an application program.

6. The LED system according to claim 4, wherein the remote control device comprises at least one of:
a touchscreen;
at least one button;
at least one key;
an alphanumeric display;
a sensor;
a gesture sensor; or
a voice recognition sensor.

7. The LED system according to claim 1, wherein said wireless transceiver comprises at least one of:
a WiFi wireless receiver;
a Bluetooth wireless receiver;
a zigbee protocol wireless receiver;
a local area network (LAN) wireless receiver; or
a wide area network (WAN) wireless receiver.

8. The LED system according to claim 1, further comprising:
at least one wireless communication antenna.

9. The LED system according to claim 1, further comprising:
at least one illuminance sensor.

10. The LED system according to claim 1, further comprising:
at least one light sensor.

11. The LED system according to claim 1, wherein said controller comprises addressability of said plurality of LEDs in groups of at least one LED.

12. The LED system according to claim 1, wherein said LED light source device comprises a colored LED light source device.
